(19) United States
(12) Patent Application Publication
(10) Pub. No.: US 2013/0259134 A1
(43) Pub. Date: Oct. 3, 2013

(54) IMAGE DECODING DEVICE AND MOTION VECTOR DECODING METHOD, AND IMAGE ENCODING DEVICE AND MOTION VECTOR ENCODING METHOD

(71) Applicant: Kazushi Sato, Kanagawa (JP)

(72) Inventor: Kazushi Sato, Kanagawa (JP)

(21) Appl. No.: 13/990,506

(22) PCT Filed: Nov. 29, 2011
(86) PCT No.: PCT/JP2011/077510

§ 371 Date: May 30, 2013

(30) Foreign Application Priority Data
Dec. 6, 2010 (JP) 2010-271769

(51) Int. Cl. H04N 7/36

(52) U.S. Cl. CPC H04N 19/00696
USPC 375/240.16

(57) ABSTRACT

A lossless decoding unit 52 obtains, from compressed image information, predicted horizontal block information indicating a block having motion vector information selected as predicted horizontal motion vector information from decoded blocks adjacent to a current block to be decoded, and predicted vertical block information indicating a block having motion vector information selected as predicted vertical motion vector information from the decoded adjacent blocks. A predicted motion vector information setting unit 73 sets the motion vector information about the block indicated by the predicted horizontal block information as the predicted horizontal motion vector information, and sets the motion vector information about the block indicated by the predicted vertical block information as the predicted vertical motion vector information. Using the set predicted horizontal motion vector information and predicted vertical motion vector information, a motion vector information generation unit of a motion compensation unit 72 generates motion vector information about the current block to be decoded. In this manner, encoding efficiency is increased.

### TECHNICAL FIELD

This technique relates to an image decoding device and a motion vector decoding method, and to an image encoding device and a motion vector encoding method. Particularly, this technique is to increase the efficiency in encoding moving images.

### BACKGROUND ART

In recent years, apparatuses that handle image information as digital information and achieve high-efficiency information transmission and accumulation in doing so, or apparatuses compliant with a standard such as MPEG for compression through orthogonal transforms like discrete cosine transforms and motion compensations, have been spreading among broadcast stations and general households.

Particularly, MPEG2 (ISO/IEC 13818-2) is defined as a general-purpose image encoding standard, and is currently used for a wide range of applications for professionals and general consumers. According to the MPEG2 compression standard, a bit rate of 4 to 8 Mbps is assigned to an interlaced image having a standard resolution of 720×480 pixels, for example. In this manner, high compression rates and excellent image quality can be realized. Also, a bit rate of 18 to 22 Mbps is assigned to a high-resolution interlaced image having 1920×1088 pixels, so as to realize high compression rates and excellent image quality.

Although a larger amount of calculation than that of a conventional encoding method such as MPEG2 or MPEG4 is required in encoding and decoding, standardization to realize higher encoding efficiency was conducted under the name of Joint Model of Enhanced-Compression Video Coding, which has become international standards as H.264 and MPEG-4 Part 10 (hereinafter referred to as “H.264/AVC (Advanced Video Coding)”).

In H.264/AVC, a macroblock formed with 16×16 pixels is divided into 16×16, 16×8, 8×16, or 8×8 pixel blocks that can have motion vector information independently of one another, as shown in FIG. 1(A). Each 8×8 pixel sub-macroblock can be further divided into 8×8, 8×4, 4×8, or 4×4 pixel motion compensation blocks that can have motion vector information independently of one another, as shown in FIG. 1(B). In MPEG-2, each unit in motion prediction/compensation operations is 16×16 pixels in a frame motion compensation mode, and is 16×8 pixels in each of a first field and a second field in a field motion compensation mode. With such units, motion prediction/compensation operations are performed.

In H.264/AVC, such motion prediction/compensation operations are performed. As a result, an enormous amount of motion vector information is generated, and encoding the motion vector information as it is will lead to a decrease in encoding efficiency.

As a means to solve such a problem, the median prediction described below is used in H.264/AVC, to realize a decrease in the amount of motion vector information.

In FIG. 2, a block E is the current block that is about to be encoded, and blocks A through D are blocks that have already been encoded and are adjacent to the current block E.

Here, X is A, B, C, D, or E, and mvX represents the motion vector information about a block X.

By using the motion vector information about the blocks A, B, and C, predicted motion vector information pmvE about the current block E is generated through a median prediction as shown in the equation (1).

pmvE=med(mvA,mvB,mvC) (1)

If the information about the adjacent block C cannot be obtained because the block C is located at a corner of the image frame or the like, the information about the adjacent block D is used instead.

In the compressed image information, the data mvdE to be encoded as the motion vector information about the current block E is generated by using pmvE as shown in the equation (2).

mvdE=mvE−pmvE (2)

In an actual operation, processing is performed on the horizontal component and the vertical component of the motion vector information independently of each other.

Also, in H.264/AVC, a multi-reference frame method is specified. Referring now to FIG. 3, the multi-reference frame method specified in H.264/AVC is described.

In MPEG2 or the like, in the case of a P-picture, a motion prediction/compensation operation is performed by referring only to one reference frame stored in a frame memory. In H.264/AVC, however, more than one reference frame is stored in memories, so that a different memory can be referred to for each block, as shown in FIG. 3.

Although the amount of motion vector information in a B-picture is very large, there is a predetermined mode called the direct mode in H.264/AVC. In the direct mode, motion vector information is not contained in compressed image information, and a decoding device extracts the motion vector information about the block from the motion vector information about a surrounding or anchor block (Co-Located Block). The anchor block is the block that has the same x-y coordinates in a reference image as the current block.

The direct mode includes a spatial direct mode and a temporal direct mode, and one of the two modes can be selected for each slice.

In the spatial direct mode, motion vector information pmvE generated through a median prediction is used as the motion vector information mvE to be used for the block, as shown in the equation (3).

mvE=pmvE (3)

Referring now to FIG. 4, the temporal direct mode is described. In FIG. 4, the block located at the same spatial address in an L0 reference picture as the block is the anchor block, and the motion vector information about the anchor block is motion “mvcol”. Also, “TDB” represents the distance on the temporal axis between the picture and the L0 reference picture, and “TDD” represents the distance on the temporal axis between the L0 reference picture and an L1 reference picture. In this case, L0 motion vector information mvL0 and L1 motion vector information mvL1 in the picture are calculated according to the equations (4) and (5).

mvL0=(TDB/TDD)mvcol (4)

mvL1=((TDD−TDB)/TDD)mvcol (5)

In the compressed image information, information indicating a distance on the temporal axis does not exist, and therefore, the calculations according to the equations (4) and (5) use POC (Picture Order Count).

In AVC compressed image information, the direct mode can be defined on a 16×16 pixel macroblock unit basis or on an 8×8 pixel sub-macroblock unit basis.

Meanwhile, Non-Patent Document 1 has suggested an improvement in the motion vector information encoding that uses a median prediction as shown in FIG. 2. According to Non-Patent Document 1, temporally predicted motion vector information or spatiotemporally predicted motion vector information can be adaptively used as well as spatially predicted motion vector information obtained through a median prediction.

That is, in FIG. 5, the motion vector information mvcol is the motion vector information about the anchor block with respect to the current block. Also, motion vector information mvtk (k=0 through 8) is the motion vector information about the surrounding blocks.

Temporally predicted motion vector information mvtm is generated from five pieces of motion vector information by using the equation (6). Alternatively, the temporally predicted motion vector information mvtm may be generated from nine pieces of motion vector information by using the equation (7).

mvtm5=med(mvcol, mvt0, . . . mvt3) (6)

mvtm9=med(mvcol, mvt0, . . . mvt7) (7)

Spatiotemporally predicted motion vector information mvspt is generated from five pieces of motion vector information by using the equation (8).

mvspt=med(mvcol,mvcol,mvA,mvB,mvC) (8)

In an image processing device that encodes image information, cost function values for respective blocks are calculated by using the predicted motion vector information about the respective blocks, and optimum predicted motion vector information is selected. Through the compressed image information, a flag for making it possible to determine which predicted motion vector information has been used is transmitted for each block.

In large frames such as UHD (Ultra High Definition: 4000×2000 pixels) frames, there are cases where the macroblock size of 16×16 pixels, which is specified in MPEG2 or H.264/AVC, is not the optimum size. For example, in large frames, there are cases where encoding efficiency can be increased by using a larger macroblock size. In view of this, coding units CU are specified in HEVC (High Efficiency Video Coding), which is a next-generation encoding method, as described in Non-Patent Document 2. According to Non-Patent Document 2, the largest size of the coding units CU (LCU=Largest Coding Unit) and the smallest size (SCU=Smallest Coding Unit) are specified in the SPS (Sequence Parameter Set) of compressed image information that is to be an output. Further, in each LCU, split-flag=1 is set within a range not lower than the SCU size, so that each LCU can be divided into coding units CU of a smaller size.

FIG. 6 shows an example hierarchical structure of coding units CU. In the example shown in FIG. 6, the largest size is 128×128 pixels, and the hierarchical depth is “5”. For example, where the hierarchical depth is “0”, a 2N×2N (N=64 pixels) block is a coding unit CU0. Where split flag=1, the coding unit CU0 is divided into four independent N×N blocks, and the N×N blocks belong to a hierarchical level that is one level lower. That is, the hierarchical level is “1”, and each 2N×2N (N=32 pixels) block is a coding unit CU1. Likewise, where split flag=1, each coding unit is divided into four independent blocks. Further, in the case of the depth “4”, which is the deepest hierarchical level, each 2N×2N (N=four pixels) block is a coding unit CU4, and 8×8 pixels is the smallest size of the coding units CU. In HEVC, prediction units (PUs) as basic units for predictions are also defined by dividing coding units.

### CITATION LIST

### Non-Patent Documents

Non-Patent Document 1: “Competition-Based Scheme for Motion Vector Selection and Coding” (VCEG-AC06, ITU—Telecommunications Standardization Sector. STUDY GROUP 16 Question 6. Video Coding Experts Group 29th Meeting: Klagenfurt Austria, July, 2006)
Non-Patent Document 2: “Test Model under Consideration” (JCTVC-B205, 2nd JCT-VC Meeting, Geneva, CH, July 2010)

### SUMMARY OF THE INVENTION

### Problems to be Solved by the Invention

Meanwhile, Non-Patent Document 1 cannot realize a sufficient increase in encoding efficiency, since independent prediction information cannot be provided for motion vector components in the horizontal direction and the vertical direction. For example, where there are three candidates in the horizontal direction and three candidates in the vertical direction, nine kinds of flags are prepared, and an encoding operation is performed, as there are nine (3×3) combinations of the candidates in the horizontal direction and the vertical direction. However, an increase in the number of combinations leads to an increase in the number of types of flags, and the bit rate of information indicating flags becomes larger.

In view of this, this technique aims to provide an image decoding device and a motion vector decoding method, and an image encoding device and a motion vector encoding method that can increase encoding efficiency.

### Solutions to Problems

A first aspect of this technique lies in an image decoding device including: a lossless decoding unit that obtains predicted horizontal block information and predicted vertical block information from compressed image information, the predicted horizontal block information indicating a block having motion vector information selected as predicted horizontal motion vector information from decoded blocks adjacent to a current block, the predicted vertical block information indicating a block having motion vector information selected as predicted vertical motion vector information from the decoded adjacent blocks; a predicted motion vector information setting unit that sets the predicted horizontal motion vector information that is motion vector information about the block indicated by the predicted horizontal block information, and sets the predicted vertical motion vector information that is motion vector information about the block indicated by the predicted vertical block information; and a motion vector information generation unit that generates motion vector information about the current block by using the predicted horizontal motion vector information and predicted vertical motion vector information set by the predicted motion vector information setting unit.

According to this technique, in an image decoding device that performs a decoding operation on compressed image information generated by dividing input image data into pixel blocks, detecting motion vector information about each of the blocks, and performing motion-compensating prediction encoding, predicted horizontal block information indicating a block having motion vector information selected as predicted horizontal motion vector information from decoded blocks adjacent to a current block, and predicted vertical block information indicating a block having motion vector information selected as predicted vertical motion vector information are obtained from the compressed image information. The motion vector information about the block indicated by the predicted horizontal block information is set as the predicted horizontal motion vector information, and the motion vector information about the block indicated by the predicted vertical block information is set as the predicted vertical motion vector information. Motion vector information about the current block is generated by using the set predicted horizontal motion vector information and predicted vertical motion vector information.

Also, identification information is obtained from the compressed image information. The identification information indicates that the predicted horizontal motion vector information and predicted vertical motion vector information are used, or that predicted horizontal/vertical motion vector information is used. The predicted horizontal/vertical motion vector information indicates motion vector information selected from the decoded adjacent blocks for the horizontal component and the vertical component of the motion vector information about the current block. Based on the identification information, the predicted horizontal motion vector information and predicted vertical motion vector information, or the predicted horizontal/vertical motion vector information is set, and motion vector information about the current block is generated.

A second aspect of this technique lies in a motion vector information decoding method including: the step of obtaining predicted horizontal block information and predicted vertical block information from compressed image information, the predicted horizontal block information indicating a block having motion vector information selected as predicted horizontal motion vector information from decoded blocks adjacent to a current block, the predicted vertical block information indicating a block having motion vector information selected as predicted vertical motion vector information from the decoded adjacent blocks; the step of setting the predicted horizontal motion vector information that is motion vector information about the block indicated by the predicted horizontal block information, and sets the predicted vertical motion vector information that is motion vector information about the block indicated by the predicted vertical block information; and the step of generating motion vector information about the current block by using the set predicted horizontal motion vector information and predicted vertical motion vector information.

A third aspect of this technique lies in an image encoding device including a predicted motion vector information setting unit that sets, for the horizontal component and the vertical component of motion vector information about a current block, respectively, predicted horizontal motion vector information and predicted vertical motion vector information by selecting motion vector information from encoded blocks adjacent to the current block, and generates predicted horizontal block information and predicted vertical block information indicating the block having the motion vector information selected.

According to this technique, in an image encoding device that performs motion-compensating prediction encoding by dividing input image data into pixel blocks and detecting motion vector information about each of the blocks, predicted horizontal motion vector information and predicted vertical motion vector information are set for the horizontal component and the vertical component of motion vector information about a current block by selecting motion vector information from encoded blocks adjacent to the current block. For example, for the horizontal component of motion vector information obtained by conducting a motion search in the optimum prediction mode with the smallest cost function value, the motion vector information about the encoded adjacent block with the highest encoding efficiency is selected and set as the predicted horizontal motion vector information. Also, for the vertical component of motion vector information obtained by conducting a motion search in the optimum prediction mode, the motion vector information about the encoded adjacent block with the highest encoding efficiency is selected and set as the predicted vertical motion vector information. The motion vector information about the current block is compressed by using the predicted horizontal motion vector information and the predicted vertical motion vector information. Also, the predicted horizontal block information and the predicted vertical block information indicating the block having its motion vector information selected are generated, and the predicted horizontal block information and the predicted vertical block information are incorporated into the compressed image information.

Also, for the horizontal component and the vertical component of the motion vector information about the current block, motion vector information selected from the encoded blocks adjacent to the current block can be switched between the predicted horizontal/vertical motion vector information and the predicted horizontal motion vector information and predicted vertical motion vector information for each picture or slice. For example, the predicted horizontal motion vector information and predicted vertical motion vector information are set for a P-picture, and the predicted horizontal/vertical motion vector information is set for a B-picture. Further, the compressed image information contains identification information indicating that the predicted horizontal motion vector information and the predicted vertical motion vector information are used, or that the predicted horizontal/vertical motion vector information is used.

Also, codes are assigned to the predicted horizontal block information and the predicted vertical block information, for example, and the codes assigned to the predicted horizontal block information and the predicted vertical block information are incorporated into the compressed image information. Further, when an encoding operation is performed on motion vector information detected based on image data generated by an imaging apparatus, codes are assigned in accordance with the result of motion detection performed on the imaging apparatus.

A fourth aspect of this technique lies in a motion vector information encoding method including the step of setting, for the horizontal component and the vertical component of motion vector information about a current block, respectively, predicted horizontal motion vector information and predicted vertical motion vector information by selecting motion vector information from encoded blocks adjacent to the current block, and generating predicted horizontal block information and predicted vertical block information indicating the block having the motion vector information selected.

### Effects of the Invention

According to this technique, for the horizontal component and the vertical component of motion vector information about a current block, predicted horizontal motion vector information and predicted vertical motion vector information are set, respectively, by selecting motion vector information from encoded blocks adjacent to the current block, and the motion vector information about the current block is compressed by using the set predicted horizontal motion vector information and predicted vertical motion vector information. Also, predicted horizontal block information and predicted vertical block information indicating the block having its motion vector information selected are generated. Further, the motion vector information is decoded based on the predicted horizontal block information and the predicted vertical block information. Accordingly, predicted horizontal motion vector information and predicted vertical motion vector information can be set by using predicted horizontal block information and predicted vertical block information having smaller data amounts than a flag equivalent to a combination of candidates for the predicted horizontal motion vector information and the predicted vertical motion vector information. Thus, encoding efficiency can be increased.

### BRIEF DESCRIPTION OF DRAWINGS

FIG. 1 is a diagram showing blocks in H.264/AVC.

FIG. 2 is a diagram for explaining a median prediction.

FIG. 3 is a diagram for explaining the multi-reference frame method.

FIG. 4 is a diagram for explaining the temporal direct mode.

FIG. 5 is a diagram for explaining temporally predicted motion vector information and spatiotemporally predicted motion vector information.

FIG. 6 is a diagram showing example hierarchical structures of coding units CU.

FIG. 7 is a diagram showing the structure of an image encoding device.

FIG. 8 is a diagram showing the structures of the motion prediction/compensation unit and the predicted motion vector information setting unit.

FIG. 9 is a diagram for explaining a motion prediction/compensation operation with 1/4 pixel precision.

FIG. 10 is a flowchart showing operations of the image encoding device.

FIG. 11 is a flowchart showing prediction operations.

FIG. 12 is a flowchart showing intra prediction operations.

FIG. 13 is a flowchart showing inter prediction operations.

FIG. 14 is a flowchart showing a predicted motion vector information setting operation.

FIG. 15 is a diagram showing the structure of an image decoding device.

FIG. 16 is a diagram showing the structures of the motion compensation unit and the predicted motion vector information setting unit.

FIG. 17 is a flowchart showing operations of the image decoding device.

FIG. 18 is a flowchart showing a predicted image generating operation.

FIG. 19 is a flowchart showing an inter-predicted image generating operation.

FIG. 20 is a flowchart showing a motion vector information reconstructing operation.

FIG. 21 is a diagram showing another example structure of the predicted motion vector information setting unit used in the image encoding device.

FIG. 22 is a diagram showing another example structure of the predicted motion vector information setting unit used in the image decoding device.

FIG. 23 is a diagram schematically showing an example structure of a computer device.

FIG. 24 is a diagram schematically showing an example structure of a television apparatus.

FIG. 25 is a diagram schematically showing an example structure of a portable telephone device.

FIG. 26 is a diagram schematically showing an example structure of a recording/reproducing apparatus.

FIG. 27 is a diagram schematically showing an example structure of an imaging apparatus.

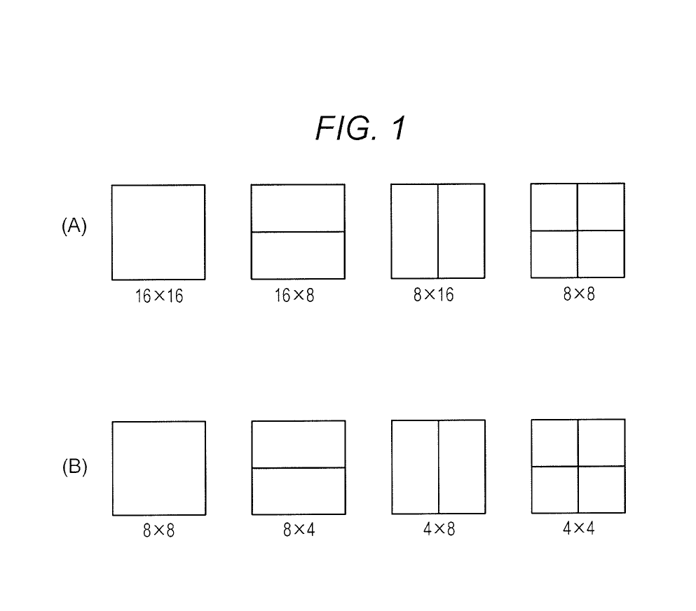

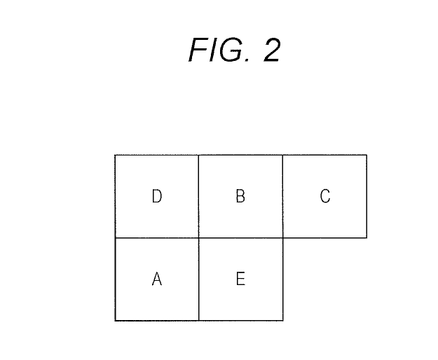

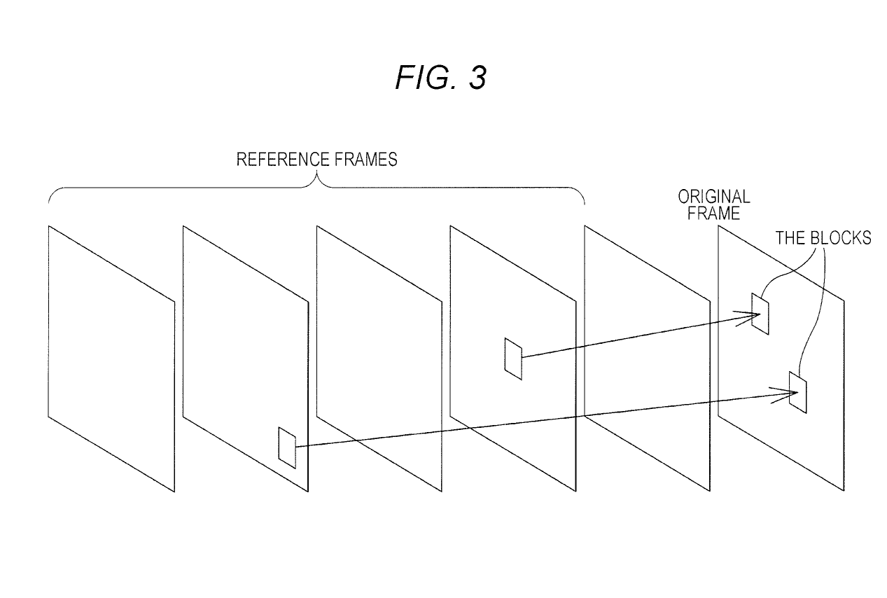

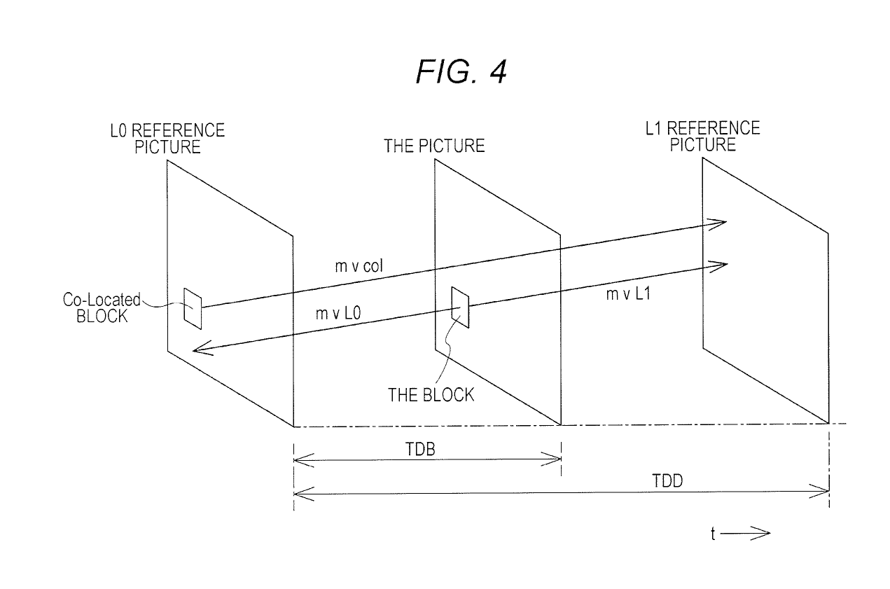

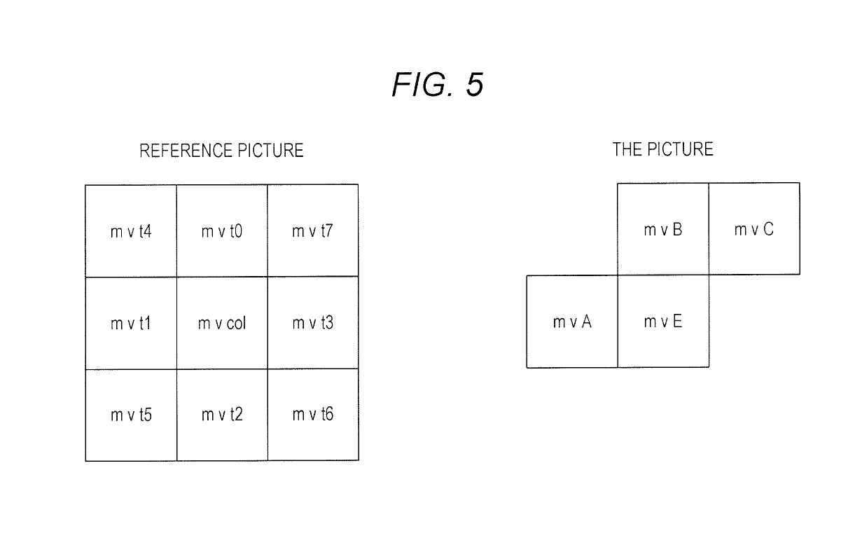

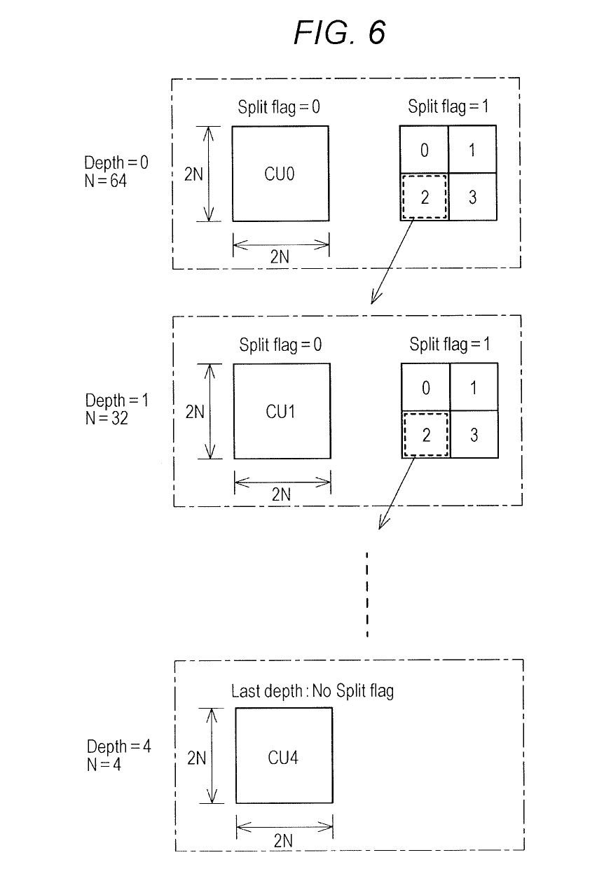

### MODE FOR CARRYING OUT THE INVENTION

The following is a description of embodiments for carrying out the technique. Explanation will be made in the following order.

### 1. Structure of an Image Encoding Device

### 2. Operations of the Image Encoding Device

### 3. Structure of an Image Decoding Device

### 4. Operations of the Image Decoding Device

### 5. Other Example Structures of the Predicted Motion Vector Information Setting Unit

### 6. Software Processing

### 7. Applications to Electronic Apparatuses

### [1. Structure of an Image Encoding Device]

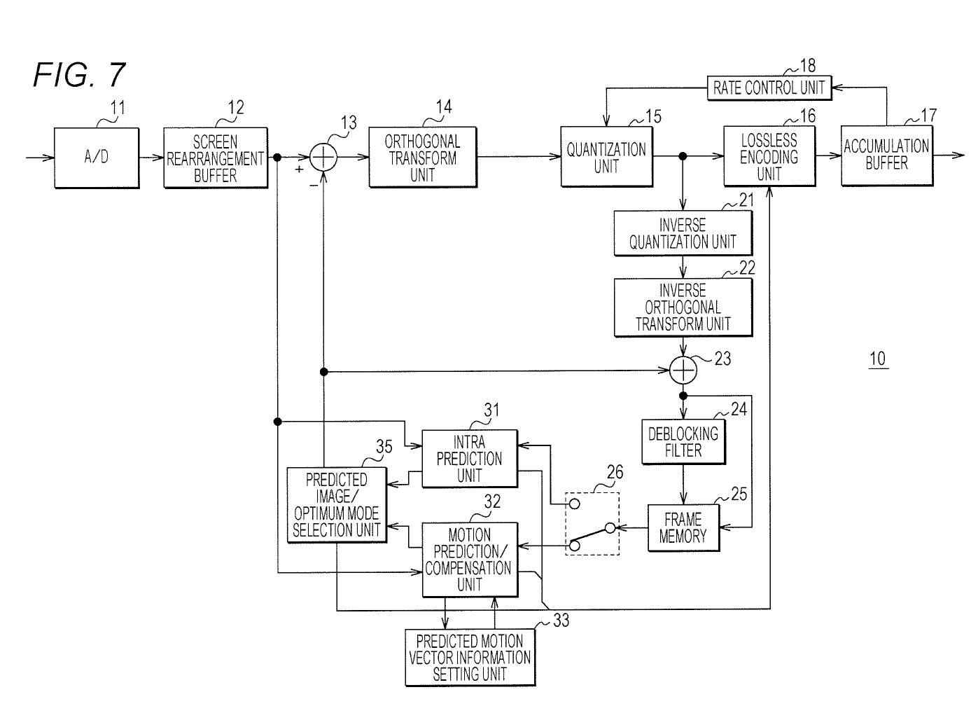

FIG. 7 shows the structure of an image encoding device. The image encoding device 10 includes an analog/digital converter (an A/D converter) 11, a screen rearrangement buffer 12, a subtraction unit 13, an orthogonal transform unit 14, a quantization unit 15, a lossless encoding unit 16, an accumulation buffer 17, and a rate control unit 18. The image encoding device 10 further includes an inverse quantization unit 21, an inverse orthogonal transform unit 22, an addition unit 23, a deblocking filter 24, a frame memory 25, an intra prediction unit 31, a motion prediction/compensation unit 32, a predicted motion vector information setting unit 33, and a predicted image/optimum mode selection unit 35.

The A/D converter 11 converts analog image signals into digital image data, and outputs the image data to the screen rearrangement buffer 12.

The screen rearrangement buffer 12 rearranges the frames of the image data output from the A/D converter 11. The screen rearrangement buffer 12 rearranges the frames in accordance with the GOP (Group of Pictures) structure related to encoding operations, and outputs the rearranged image data to the subtraction unit 13, the intra prediction unit 31, and the motion prediction/compensation unit 32.

The subtraction unit 13 receives the image data output from the screen rearrangement buffer 12 and predicted image data selected by the later described predicted image/optimum mode selection unit 35. The subtraction unit 13 calculates prediction error data that is the difference between the image data output from the screen rearrangement buffer 12 and the predicted image data supplied from the predicted image/optimum mode selection unit 35, and outputs the prediction error data to the orthogonal transform unit 14.

The orthogonal transform unit 14 performs an orthogonal transform operation, such as a discrete cosine transform (DCT) or a Karhunen-Loeve transform, on the prediction error data output from the subtraction unit 13. The orthogonal transform unit 14 outputs transform coefficient data obtained by performing the orthogonal transform operation to the quantization unit 15.

The quantization unit 15 receives the transform coefficient data output from the orthogonal transform unit 14 and a rate control signal supplied from the later described rate control unit 18. The quantization unit 15 quantizes the transform coefficient data, and outputs the quantized data to the lossless encoding unit 16 and the inverse quantization unit 21. Based on the rate control signal supplied from the rate control unit 18, the quantization unit 15 switches quantization parameters (quantization scales), to change the bit rate of the quantized data.

The lossless encoding unit 16 receives the quantized data output from the quantization unit 15, prediction mode information from the later described intra prediction unit 31, and prediction mode information and the like from the motion prediction/compensation unit 32. Also, information indicating whether an optimum mode is an intra prediction or an inter prediction is supplied from the predicted image/optimum mode selection unit 35. The prediction mode information contains information indicating a prediction mode, block size information about a prediction unit, and the like, in accordance with whether the prediction mode is an intra prediction or an inter prediction. The lossless encoding unit 16 performs a lossless encoding operation on the quantized data through variable-length coding or arithmetic coding or the like, to generate and output compressed image information to the accumulation buffer 17. When the optimum mode is an intra prediction, the lossless encoding unit 16 performs lossless encoding on the prediction mode information supplied from the intra prediction unit 31. When the optimum mode is an inter prediction, the lossless encoding unit 16 performs lossless encoding on the prediction mode information, predicted block information, the difference motion vector information, and the like supplied from the motion prediction/compensation unit 32. Further, the lossless encoding unit 16 incorporates the information subjected to the lossless encoding into the compressed image information. For example, the lossless encoding unit 16 adds the information to the header information in an encoded stream that is the compressed image information.

The accumulation buffer 17 stores the compressed image information supplied from the lossless encoding unit 16. The accumulation buffer 17 also outputs the stored compressed image information at a transmission rate suitable for the transmission path.

The rate control unit 18 monitors the free space in the accumulation buffer 17, generates a rate control signal in accordance with the free space, and outputs the rate control signal to the quantization unit 15. The rate control unit 18 obtains information indicating the free space from the accumulation buffer 17, for example. When the remaining free space is small, the rate control unit 18 lowers the bit rate of the quantized data through the rate control signal. When the remaining free space in the accumulation buffer 17 is sufficiently large, the rate control unit 18 increases the bit rate of the quantized data through the rate control signal.

The inverse quantization unit 21 inversely quantizes the quantized data supplied from the quantization unit 15. The inverse quantization unit 21 outputs the transform coefficient data obtained by performing the inverse quantization operation to the inverse orthogonal transform unit 22.

The inverse orthogonal transform unit 22 performs an inverse orthogonal transform operation on the transform coefficient data supplied from the inverse quantization unit 21, and outputs the resultant data to the addition unit 23.

The addition unit 23 adds the data supplied from the inverse orthogonal transform unit 22 to the predicted image data supplied from predicted image/optimum mode selection unit 35, to generate decoded image data. The addition unit 23 then outputs the decoded image data to the deblocking filter 24 and the frame memory 25. The decoded image data is used as the image data of a reference image.

The deblocking filter 24 performs a filtering operation to reduce block distortions that occur at the time of image encoding. The deblocking filter 24 performs a filtering operation to remove block distortions from the decoded image data supplied from the addition unit 23, and outputs the filtered decoded image data to the frame memory 25.

The frame memory 25 stores the decoded image data that has not been subjected to the filtering operation and been supplied from the addition unit 23, and the decoded image data that has been subjected to the filtering operation and been supplied from the deblocking filter 24. The decoded image data stored in the frame memory 25 is supplied as reference image data to the intra prediction unit 31 or the motion prediction/compensation unit 32 via a selector 26.

When an intra prediction is performed at the intra prediction unit 31, the selector 26 supplies the decoded image data that has not been subjected to the deblocking filtering operation and is stored in the frame memory 25, as reference image data, to the intra prediction unit 31. When an inter prediction is performed at the motion prediction/compensation unit 32, the selector 26 supplies the decoded image data that has been subjected to the deblocking filtering operation and is stored in the frame memory 25, as reference image data, to the motion prediction/compensation unit 32.

Using the input image data supplied from the screen rearrangement buffer 12 and the reference image data supplied from the frame memory 25, the intra prediction unit 31 performs predictions on the current block in all candidate intra prediction modes, to determine an optimum intra prediction mode. The intra prediction unit 31 calculates a cost function value in each of the intra prediction modes, for example, and sets the optimum intra prediction mode that is the intra prediction mode with the highest encoding efficiency, based on the calculated cost function values. The intra prediction unit 31 outputs the predicted image data generated in the optimum intra prediction mode and the cost function value in the optimum intra prediction mode to the predicted image/optimum mode selection unit 35. The intra prediction unit 31 further outputs prediction mode information indicating the optimum intra prediction mode to the lossless encoding unit 16.

Using the input image data supplied from the screen rearrangement buffer 12 and the reference image data supplied from the frame memory 25, the motion prediction/compensation unit 32 performs predictions on the current block in all candidate inter prediction modes, to determine an optimum inter prediction mode. The motion prediction/compensation unit 32 calculates a cost function value in each of the inter prediction modes, for example, and sets the optimum inter prediction mode that is the inter prediction mode with the highest encoding efficiency, based on the calculated cost function values. Using predicted block information and difference motion vector information generated by the predicted motion vector information setting unit 33, the motion prediction/compensation unit 32 calculates cost function values. Further, the motion prediction/compensation unit 32 outputs the predicted image data generated in the optimum inter prediction mode and the cost function value in the optimum inter prediction mode to the predicted image/optimum mode selection unit 35. The motion prediction/compensation unit 32 also outputs prediction mode information about the optimum inter prediction mode, the predicted block information, the difference motion vector information, and the like, to the lossless encoding unit 16.

The predicted motion vector information setting unit 33 sets the horizontal motion vector information about encoded adjacent blocks as candidates for predicted horizontal motion vector information about the current block. The predicted motion vector information setting unit 33 also generates difference motion vector information for each candidate, with the difference motion vector information indicating the difference between the candidate predicted horizontal motion vector information and the horizontal motion vector information about the current block. Further, the predicted motion vector information setting unit 33 sets the horizontal motion vector information with the highest encoding efficiency in encoding the difference motion vector information among the candidates, as the predicted horizontal motion vector information. The predicted motion vector information setting unit 33 generates predicted horizontal block information indicating to which adjacent block the set predicted horizontal motion vector information belongs. For example, a flag (hereinafter referred to as the “predicted horizontal block flag”) is generated as the predicted horizontal block information.

The predicted motion vector information setting unit 33 sets the vertical motion vector information about the encoded adjacent blocks as candidates for predicted vertical motion vector information about the current block. The predicted motion vector information setting unit 33 also generates difference motion vector information for each candidate, with the difference motion vector information indicating the difference between the candidate predicted vertical motion vector information and the vertical motion vector information about the current block. Further, the predicted motion vector information setting unit 33 sets the vertical motion vector information with the highest encoding efficiency in encoding the difference motion vector information among the candidates, as the predicted vertical motion vector information. The predicted motion vector information setting unit 33 generates predicted vertical block information indicating to which adjacent block the set predicted vertical motion vector information belongs. For example, a flag (hereinafter referred to as the “predicted vertical block flag”) is generated as the predicted vertical block information.

Further, the predicted motion vector information setting unit 33 uses the motion vector information about the block indicated by the predicted block flag as the predicted motion vector information about the horizontal component and the vertical component. The predicted motion vector information setting unit 33 also calculates the difference motion vector information that is the difference between the motion vector information about the current block and the predicted motion vector information about the horizontal component and the vertical component, and outputs the calculated difference motion vector information to the motion prediction/compensation unit 32.

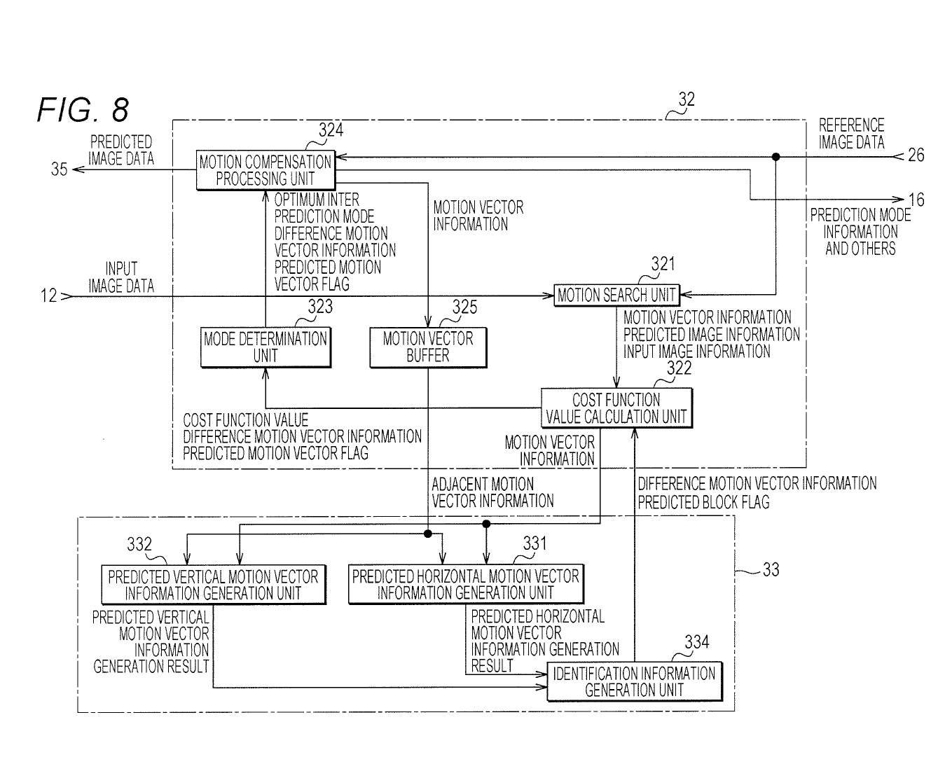

FIG. 8 shows the structures of the motion prediction/compensation unit 32 and the predicted motion vector information setting unit 33. The motion prediction/compensation unit 32 includes a motion search unit 321, a cost function value calculation unit 322, a mode determination unit 323, a motion compensation processing unit 324, and a motion vector information buffer 325.

Rearranged input image data supplied from the screen rearrangement buffer 12, and reference image data read from the frame memory 25 are supplied to the motion search unit 321. The motion search unit 321 conducts motion searches in all the candidate inter prediction modes, to detect a motion vector. The motion search unit 321 outputs the motion vector information indicating the detected motion vector, together with the input image data and reference image data for a case where a motion vector has been detected, to the cost function value calculation unit 322.

To the cost function value calculation unit 322, the motion vector information, the input image data, and the reference image data are supplied from the motion search unit 321, and the predicted block information and the difference motion vector information are supplied from the predicted motion vector information setting unit 33. Using the motion vector information, the input image data, the reference image data, the predicted block flag, and the difference motion vector information, the cost function value calculation unit 322 calculates cost function values in all the candidate inter prediction modes.

As specified in the JM (Joint Model), which is the reference software in H.264/AVC, the cost function values are calculated by the method of High Complexity Mode or Low Complexity Mode.

Specifically, in the High Complexity Mode, the operation that ends with the lossless encoding operation is provisionally performed in each candidate prediction mode, to calculate the cost function value expressed by the following equation (9) in each prediction mode.

Cost(ModeεΩ)=D+λ·R (9)

Here, Ω represents the universal set of the candidate prediction modes for encoding the image of the block. D represents the difference energy (distortion) between the decoded image and the input image in a case where encoding is performed in a prediction mode. R represents the bit generation rate including orthogonal transform coefficients, prediction mode information, predicted block information, difference motion vector information, and the like, and λ represents the Lagrange multiplier given as the function of a quantization parameter QP.

That is, to perform encoding in the High Complexity Mode, a provisional encoding operation needs to be performed in all the candidate prediction modes to calculate the above parameters D and R, and therefore, a larger amount of calculation is required.

In the Low Complexity Mode, on the other hand, predicted images and header bits containing predicted block information, difference motion vector information, prediction mode information, and the like are generated in all the candidate prediction modes, to calculate cost function values expressed by the following equation (10).

Cost(ModeεΩ)=D+QP2Quant(QP)·Header_Bit (10)

Here, Ω represents the universal set of the candidate prediction modes for encoding the image of the block. D represents the difference energy (distortion) between the decoded image and the input image in a case where encoding is performed in a prediction mode. Header_Bit represents the header bit corresponding to the prediction mode, and QP2Quant is the function given as the function of the quantization parameter QP.

That is, in the Low Complexity Mode, a prediction operation needs to be performed in each prediction mode, but any decoded image is not required. Accordingly, the amount of calculation can be smaller than that required in the High Complexity Mode.

The cost function value calculation unit 322 outputs the calculated cost function values to the mode determination unit 323.

The mode determination unit 323 determines the mode with the smallest cost function value to be the optimum inter prediction mode. The mode determination unit 323 also outputs optimum inter prediction mode information indicating the determined optimum inter prediction mode, as well as the motion vector information, the predicted block flag, the difference motion vector information, and the like related to the optimum inter prediction mode, to the motion compensation processing unit 324. Here, the prediction mode information contains the block size information and the like.

Based on the optimum inter prediction mode information and the motion vector information, the motion compensation processing unit 324 performs motion compensation on the reference image data read from the frame memory 25, generates predicted image data, and outputs the predicted image data to the predicted image/optimum mode selection unit 35. The motion compensation processing unit 324 also outputs the prediction mode information about the optimum inter prediction, the difference motion vector information in the mode, and the like, to the lossless encoding unit 16.

The motion vector information buffer 325 stores the motion vector information about the optimum inter prediction mode. The motion vector information buffer 325 also outputs the motion vector information about an encoded block adjacent to the current block to be encoded, to the predicted motion vector information setting unit 33.

The motion prediction/compensation unit 32 performs a motion prediction/compensation operation with 1/4 pixel precision, which is specified in H.264/AVC, for example.

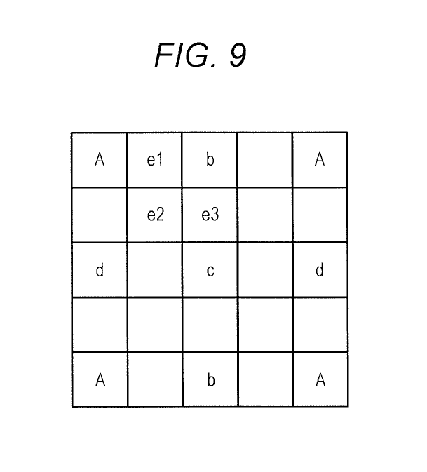

FIG. 9 is a diagram for explaining a motion prediction/compensation operation with 1/4 pixel precision. In FIG. 9, position “A” represents the location of each integer precision pixel stored in the frame memory 25, positions “b”, “c”, and “d” represent the locations with 1/2 pixel precision, positions “e1”, “e2”, and “e3” represent the locations with 1/4 pixel precision.

In the following, Clip1( ) is defined as shown in the equation (11).

$$\begin{matrix}[ Mathematical Formula 1 ] & \\ Clip 1 ( a ) = \{ \begin{matrix}0 ; & if ( a < 0 ) \\ a ; & otherwise \\ max\_pix ; & if ( a > max\_pix )\end{matrix} & ( 11 )\end{matrix}$$

In the equation (11), the value of max pix is 255 when an input image has 8-bit precision.

The pixel values at the locations “b” and “d” are generated by using a 6-tap FIR filter as shown in the equations (12) and (13).

F=A₋₂−5·A₋₁+20·A₀+20·A₁−5·A₂+A₃ (12)

b,d=Clip1((F+16)>>5) (13)

The pixel value in the position “c” is generated by using a 6-tap FIR filter as shown in the equation (14) or (15) and the equation (16).

F=b₋₂−5·b₋₁+20·b₀+20·b₁−5·b₂+b₃ (14)

F=d₋₂−5·d₋₁+20·d₀+20·d₁−5·d₂+d₃ (15)

c=Clip1((F+512)>>10) (16)

The Clip1 processing is performed only once at last, after product-sum operations are performed both in the horizontal direction and the vertical direction.

The pixel values at the locations “e1” through “e3” are generated by linear interpolations as shown in the equations (17) through (19).

e1=(A+b+1)>>1 (17)

e2=(b+d+1)>>1 (18)

e3=(b+c+1)>>1 (19)

In this manner, the motion prediction/compensation unit 32 performs a motion prediction/compensation operation with 1/4 pixel precision.

The predicted motion vector information setting unit 33 includes a predicted horizontal motion vector information generation unit 331, a predicted vertical motion vector information generation unit 332, and an identification information generation unit 334.

For the horizontal component of the motion vector information about the current block, the predicted horizontal motion vector information generation unit 331 sets the predicted horizontal motion vector information with the highest encoding efficiency in the encoding operation. The predicted horizontal motion vector information generation unit 331 sets candidate predicted horizontal motion vector information that is the horizontal motion vector information about encoded adjacent blocks supplied from the motion prediction/compensation unit 32. The predicted horizontal motion vector information generation unit 331 also generates horizontal difference motion vector information indicating the difference between the horizontal motion vector information about each candidate and the horizontal motion vector information about the current block supplied from the motion prediction/compensation unit 32. Further, the predicted horizontal motion vector information generation unit 331 sets predicted horizontal motion vector information that is the horizontal motion vector information about the candidate having the lowest bit rate in the horizontal difference motion vector information. The predicted horizontal motion vector information generation unit 331 outputs the predicted horizontal motion vector information and the horizontal difference motion vector information obtained with the use of the predicted horizontal motion vector information, as the result of the generation of the predicted horizontal motion vector information, to the identification information generation unit 334.

For the vertical component of the motion vector information about the current block, the predicted vertical motion vector information generation unit 332 sets the predicted vertical motion vector information with the highest encoding efficiency in the encoding operation. The predicted vertical motion vector information generation unit 332 sets candidate predicted vertical motion vector information that is the vertical motion vector information about the encoded adjacent blocks supplied from the motion prediction/compensation unit 32. The predicted vertical motion vector information generation unit 332 also generates vertical difference motion vector information indicating the difference between the vertical motion vector information about each candidate and the vertical motion vector information about the current block supplied from the motion prediction/compensation unit 32. Further, the predicted horizontal motion vector information generation unit 331 sets predicted vertical motion vector information that is the vertical motion vector information about the candidate having the lowest bit rate in the vertical difference motion vector information. The predicted vertical motion vector information generation unit 332 outputs the predicted vertical motion vector information and the vertical difference motion vector information obtained with the use of the predicted vertical motion vector information, as the result of the generation of the predicted vertical motion vector information, to the identification information generation unit 334.

Based on the result of the generation of the predicted horizontal motion vector information, the identification information generation unit 334 generates predicted horizontal block information, or the predicted horizontal block flag, for example, which indicates the block having its motion vector information selected as the predicted horizontal motion vector information. The identification information generation unit 334 outputs the generated predicted horizontal block flag and the horizontal difference motion vector information to the cost function value calculation unit 322 of the motion prediction/compensation unit 32. Based on the result of the generation of the predicted vertical motion vector information, the identification information generation unit 334 also generates predicted vertical block information, or the predicted vertical block flag, for example, which indicates the block having its motion vector information selected as the predicted vertical motion vector information. The identification information generation unit 334 outputs the generated predicted vertical block flag and the vertical difference motion vector information to the cost function value calculation unit 322 of the motion prediction/compensation unit 32.

The predicted motion vector information setting unit 33 may supply the difference motion vector information indicating the difference between the horizontal (vertical) motion vector information about the current block and the motion vector information about each candidate, together with information indicating the candidate blocks, to the cost function value calculation unit 322. In this case, the horizontal (vertical) motion vector information about the candidate having the smallest one of the cost function values calculated by the cost function value calculation unit 322 is set as the predicted horizontal (vertical) motion vector information. The identification information indicating the candidate block having the smallest cost function value is used in inter predictions.

Referring back to FIG. 7, the predicted image/optimum mode selection unit 35 compares the cost function value supplied from the intra prediction unit 31 with the cost function value supplied from the motion prediction/compensation unit 32, and selects the one having the smaller cost function value as the optimum mode with the highest encoding efficiency. The predicted image/optimum mode selection unit 35 also outputs the predicted image data generated in the optimum mode to the subtraction unit 13 and the addition unit 23. Further, the predicted image/optimum mode selection unit 35 outputs information indicating whether the optimum mode is an intra prediction mode or an inter prediction mode, to the lossless encoding unit 16. The predicted image/optimum mode selection unit 35 switches to an intra prediction or to an inter prediction for each slice.

### [2. Operations of the Image Encoding Device]

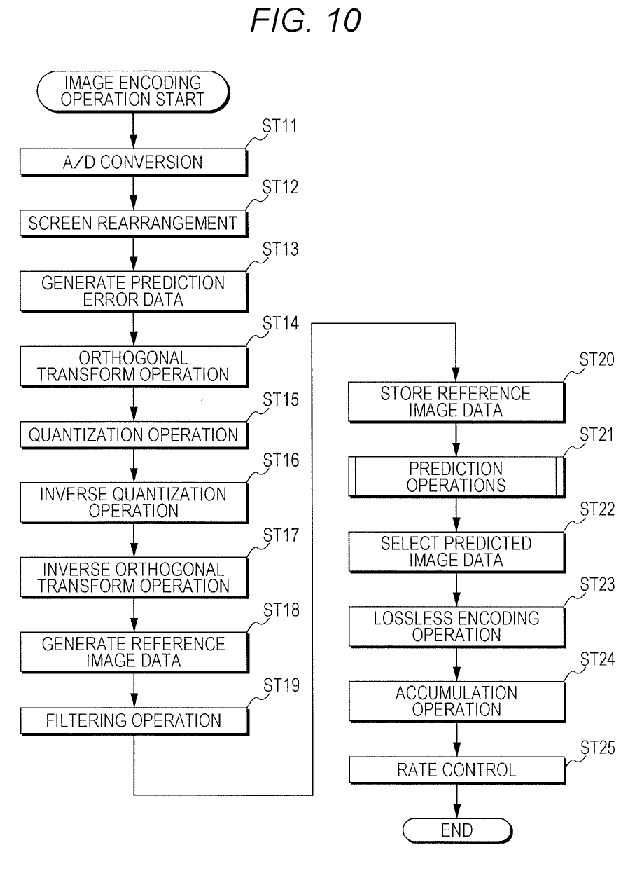

FIG. 10 is a flowchart showing operations of the image encoding device. In step ST11, the A/D converter 11 performs an A/D conversion on an input image signal.

In step ST12, the screen rearrangement buffer 12 performs image rearrangement. The screen rearrangement buffer 12 stores the image data supplied from the A/D converter 11, and rearranges the respective pictures in encoding order, instead of display order.

In step ST13, the subtraction unit 13 generates prediction error data. The subtraction unit 13 generates the prediction error data by calculating the difference between the image data of the images rearranged in step ST12 and predicted image data selected by the predicted image/optimum mode selection unit 35. The prediction error data has a smaller data amount than the original image data. Accordingly, the data amount can be made smaller than in a case where images are directly encoded.

In step ST14, the orthogonal transform unit 14 performs an orthogonal transform operation. The orthogonal transform unit 14 orthogonally transforms the prediction error data supplied from the subtraction unit 13. Specifically, orthogonal transforms such as discrete cosine transforms or Karhunen-Loeve transforms are performed on the prediction error data, and transform coefficient data is output.

In step ST15, the quantization unit 15 performs a quantization operation. The quantization unit 15 quantizes the transform coefficient data. In the quantization, rate control is performed as will be described later in the description of step ST25.

In step ST16, the inverse quantization unit 21 performs an inverse quantization operation. The inverse quantization unit 21 inversely quantizes the transform coefficient data quantized at the quantization unit 15, having characteristics compatible with the characteristics of the quantization unit 15.

In step ST17, the inverse orthogonal transform unit 22 performs an inverse orthogonal transform operation. The inverse orthogonal transform unit 22 performs an inverse orthogonal transform on the transform coefficient data inversely quantized at the inverse quantization unit 21, having the characteristics compatible with the characteristics of the orthogonal transform unit 14.

In step ST18, the addition unit 23 generates reference image data. The addition unit 23 generates the reference image data (decoded image data) by adding the predicted image data supplied from the predicted image/optimum mode selection unit 35 to the data of the location that corresponds to the predicted image and has been subjected to the inverse orthogonal transform.

In step ST19, the deblocking filter 24 performs a filtering operation. The deblocking filter 24 removes block distortions by filtering the decoded image data output from the addition unit 23.

In step ST20, the frame memory 25 stores the reference image data. The frame memory 25 stores the filtered reference image data (the decoded image data).

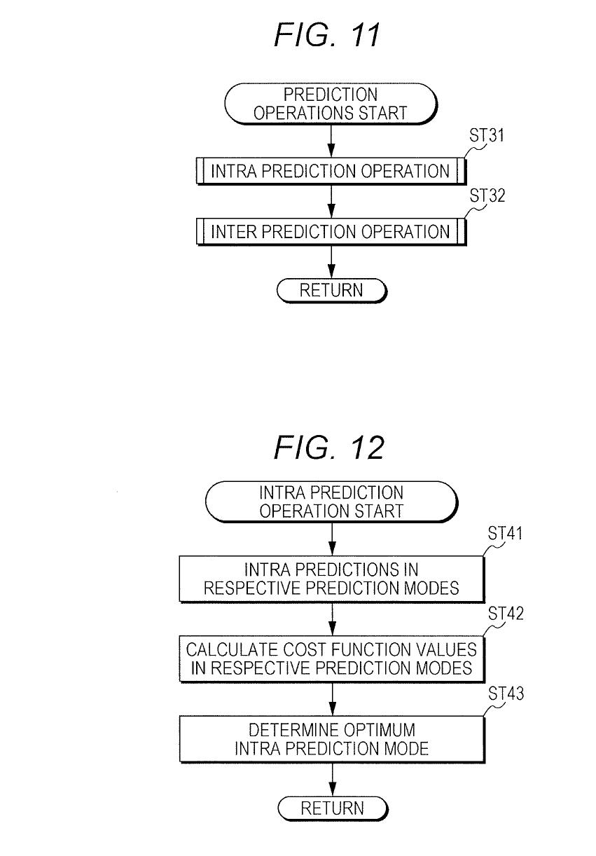

In step ST21, the intra prediction unit 31 and the motion prediction/compensation unit 32 each perform prediction operations. Specifically, the intra prediction unit 31 performs intra prediction operations in intra prediction modes, and the motion prediction/compensation unit 32 performs motion prediction/compensation operations in inter prediction modes. The prediction operations will be described later in detail with reference to FIG. 11. In this step, prediction operations are performed in all candidate prediction modes, and cost function values are calculated in all the candidate prediction modes. Based on the calculated cost function values, an optimum intra prediction mode and an optimum inter prediction mode are selected, and the predicted images generated in the selected prediction modes, the cost function values, and the prediction mode information are supplied to the predicted image/optimum mode selection unit 35.

In step ST22, the predicted image/optimum mode selection unit 35 selects predicted image data. Based on the respective cost function values output from the intra prediction unit 31 and the motion prediction/compensation unit 32, the predicted image/optimum mode selection unit 35 determines the optimum mode to optimize the encoding efficiency. The predicted image/optimum mode selection unit 35 further selects the predicted image data in the determined optimum mode, and outputs the selected predicted image data to the subtraction unit 13 and the addition unit 23. This predicted image data is used in the operations in steps ST13 and ST18, as described above.

In step ST23, the lossless encoding unit 16 performs a lossless encoding operation. The lossless encoding unit 16 performs lossless encoding on the quantized data output from the quantization unit 15. That is, lossless encoding such as variable-length encoding or arithmetic encoding is performed on the quantized data, to compress the data. The lossless encoding unit 16 also performs lossless encoding on the prediction mode information and the like corresponding to the predicted image data selected in step ST22, so that lossless-encoded data of the prediction mode information and the like is incorporated into the compressed image information generated by performing lossless encoding on the quantized data.

In step ST24, the accumulation buffer 17 performs an accumulation operation. The accumulation buffer 17 stores the compressed image information output from the lossless encoding unit 16. The compressed image information stored in the accumulation buffer 17 is read and transmitted to the decoding side via a transmission path where necessary.

In step ST25, the rate control unit 18 performs rate control. The rate control unit 18 controls the quantization operation rate of the quantization unit 15 so that an overflow or an underflow does not occur in the accumulation buffer 17 when the accumulation buffer 17 stores compressed image information.

Referring now to the flowchart in FIG. 11, the prediction operations in step ST21 in FIG. 10 are described.

In step ST31, the intra prediction unit 31 performs an intra prediction operation. The intra prediction unit 31 performs intra predictions on the image of the current block in all the candidate intra prediction modes. The image data of a decoded image to be referred to in each intra prediction is decoded image data yet to be subjected to a blocking filtering operation at the deblocking filter 24. In this intra prediction operation, intra predictions are performed in all the candidate intra prediction modes, and cost function values are calculated in all the candidate intra prediction modes. Based on the calculated cost function values, the intra prediction mode with the highest encoding efficiency is selected from all the intra prediction modes.

In step ST32, the motion prediction/compensation unit 32 performs an inter prediction operation. Using the decoded image data that is stored in the frame memory 25 and has been subjected to the deblocking filtering operation, the motion prediction/compensation unit 32 performs inter prediction operations in the candidate inter prediction modes. In this inter prediction operation, prediction operations are performed in all the candidate inter prediction modes, and cost function values are calculated in all the candidate inter prediction modes. Based on the calculated cost function values, the inter prediction mode with the highest encoding efficiency is selected from all the inter prediction modes.

Referring now to the flowchart in FIG. 12, the intra prediction operation in step ST31 in FIG. 11 is described.

In step ST41, the intra prediction unit 31 performs intra predictions in the respective prediction modes. Using the decoded image data yet to be subjected to the blocking filtering operation, the intra prediction unit 31 generates predicted image data in each intra prediction mode.

In step ST42, the intra prediction unit 31 calculates the cost function value in each prediction mode. As specified in the JM (Joint Model), which is the reference software in H.264/AVC, the cost function values are calculated by the method of High Complexity Mode or Low Complexity Mode as described above, for example. Specifically, in the High Complexity Mode, the operation that ends with the lossless encoding operation is provisionally performed as the operation of step ST42 in all the candidate prediction modes, to calculate the cost function value expressed by the equation (9) in each prediction mode. In the Low Complexity Mode, the generation of a predicted image and the calculation of the header bit such as motion vector information and prediction mode information are performed as the operation of step ST42 in all the candidate prediction modes, and the cost function value expressed by the equation (10) is calculated in each prediction mode.

In step ST43, the intra prediction unit 31 determines the optimum intra prediction mode. Based on the cost function values calculated in step ST42, the intra prediction unit 31 selects the one intra prediction mode with the smallest cost function value among the calculated cost function values, and determines the selected intra prediction mode to be the optimum intra prediction mode.

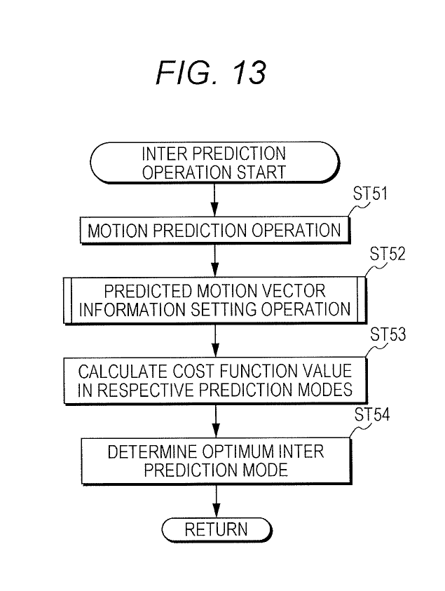

Referring now to the flowchart in FIG. 13, the inter prediction operation in step ST32 in FIG. 11 is described.

In step ST51, the motion prediction/compensation unit 32 performs motion prediction operations. The motion prediction/compensation unit 32 performs a motion prediction in each prediction mode, to detect a motion vector, and moves on to step ST52.

In step ST52, the predicted motion vector information setting unit 33 performs a predicted motion vector information setting operation. The predicted motion vector information setting unit 33 generates a predicted block flag and difference motion vector information about the current block.

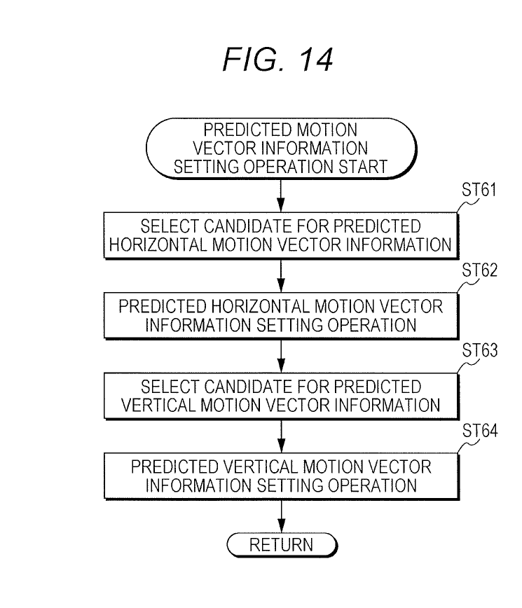

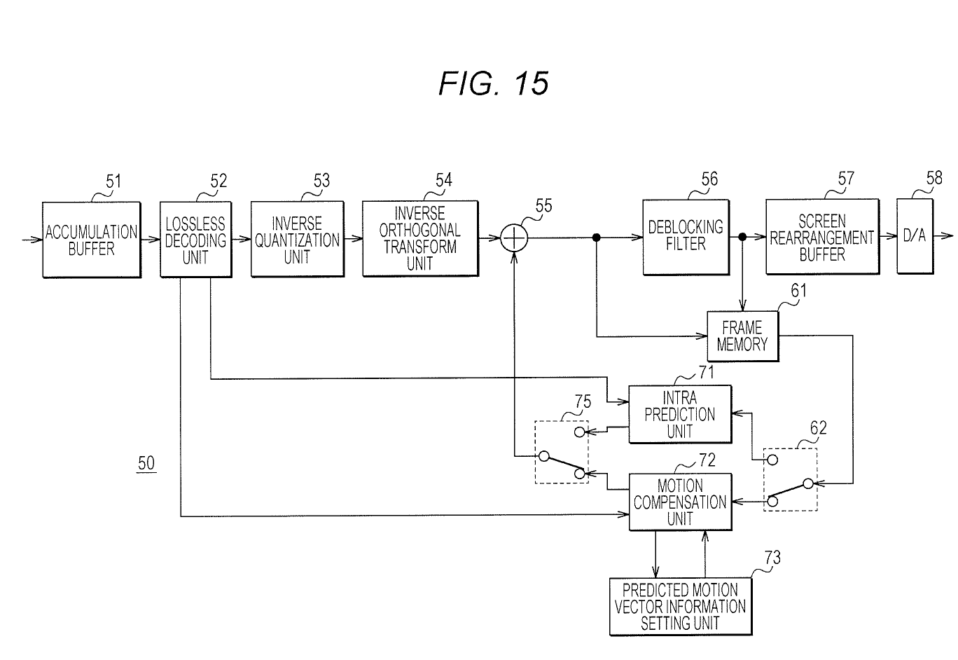

FIG. 14 is a flowchart showing the predicted motion vector information setting operation. In step ST61, the predicted motion vector information setting unit 33 selects a candidate for predicted horizontal motion vector information. The predicted motion vector information setting unit 33 selects the horizontal motion vector information about an encoded block adjacent to the current block as the candidate for the predicted horizontal motion vector information, and moves on to step ST62.

In step ST62, the predicted motion vector information setting unit 33 performs a predicted horizontal motion vector information setting operation. Based on the equation (20), for example, the predicted motion vector information setting unit 33 detects the ith horizontal motion vector information with the lowest bit rate in the horizontal difference motion vector information.

argᵢmin(R(mvx−pmvx(i))) (20)

Here, “mvx” represents the horizontal motion vector information about the current block, and “pmvx(i)” represents the ith candidate for the predicted horizontal motion vector information. Also, “R(mvx−pmvx(i))” represents the bit rate at the time of encoding the horizontal difference motion vector information indicating the difference between the ith candidate for predicted horizontal motion vector information and the horizontal motion vector information about the current block.

The predicted motion vector information setting unit 33 generates the predicted horizontal block flag indicating the adjacent block having the horizontal motion vector information with the lowest bit rate detected based on the equation (20). The predicted motion vector information setting unit 33 also generates the horizontal difference motion vector information with the use of the horizontal motion vector information, and moves on to step ST63.

In step ST63, the predicted motion vector information setting unit 33 selects a candidate for predicted vertical motion vector information. The predicted motion vector information setting unit 33 selects the vertical motion vector information about an encoded block adjacent to the current block as the candidate for the predicted vertical motion vector information, and moves on to step ST64.

In step ST64, the predicted motion vector information setting unit 33 performs a predicted vertical motion vector information setting operation. Based on the equation (21), for example, the predicted motion vector information setting unit 33 detects the jth vertical motion vector information with the lowest bit rate in the vertical difference information.

argⱼmin(R(mvy−pmvy(j))) (21)

Here, “mvy” represents the vertical motion vector information about the current block, and “pmvy(j)” represents the jth candidate for the predicted vertical motion vector information. Also, “R(mvy−pmvy(j))” represents the bit rate at the time of encoding the vertical difference motion vector information indicating the difference between the jth candidate for predicted vertical motion vector information and the vertical motion vector information about the current block.

The predicted motion vector information setting unit 33 generates the predicted vertical block flag indicating the adjacent block having the vertical motion vector information with the lowest bit rate detected based on the equation (21). The predicted motion vector information setting unit 33 also generates the vertical difference motion vector information with the use of the vertical motion vector information, and ends the predicted motion vector information setting operation. The operation then returns to step ST53 in FIG. 13.

In step ST53, the motion prediction/compensation unit 32 calculates a cost function value in each prediction mode. Using the above mentioned equation (9) or (10), the motion prediction/compensation unit 32 calculates the cost function values. Using the difference motion vector information, the motion prediction/compensation unit 32 also calculates a bit generation rate. The cost function value calculations in the inter prediction modes involve the evaluations of cost function values in the skipped macroblock mode or the direct mode specified in H.264/AVC.

In step ST54, the motion prediction/compensation unit 32 determines the optimum inter prediction mode. Based on the cost function values calculated in step ST54, the motion prediction/compensation unit 32 selects the one prediction mode with the smallest cost function value among the calculated cost function values, and determines the selected prediction mode to be the optimum inter prediction mode.

As described above, the image encoding device 10 sets a predicted horizontal motion vector and a predicted vertical motion vector of the current block separately from each other. The image encoding device 10 also performs variable-length encoding on the horizontal difference motion vector information that is the difference between the horizontal motion vector information about the current block and the predicted horizontal motion vector information. The image encoding device 10 also performs variable-length encoding on the vertical difference motion vector information that is the difference between the vertical motion vector information about the current block and the predicted vertical motion vector information. The predicted block flag indicates to which one of encoded adjacent blocks the predicted horizontal motion vector information and the predicted vertical motion vector information belong.

Accordingly, the data amount of the predicted block flag can be made smaller than that in a case where predicted horizontal/vertical motion vector information shown in the equation (22) is used. As shown in the equation (22), the predicted horizontal/vertical motion vector information is the motion vector information about the adjacent block with the lowest bit rate calculated by adding the bit rate of the horizontal difference motion vector information to the bit rate of the vertical difference motion vector information.

argₖmin(R(mvx−pmvx(k))+R(mvy−pmvy(k))) (22)

For example, where there are three candidates for horizontal motion vector information and there are three candidates for vertical motion vector information, six (3+3) kinds of flags should be prepared according to the present technique. However, if a block is determined based on a bit rate calculated by adding the bit rate of the horizontal difference motion vector information to the bit rate of the vertical difference motion vector information, nine (3×3) kinds of flags need to be prepared. That is, the number of flags to be prepared can be reduced according to the present technique, and accordingly, the efficiency in encoding motion vector information can be increased.

### [3. Structure of an Image Decoding Device]

Next, an image decoding device is described. Compressed image information generated by encoding an input image is supplied to an image decoding device via a predetermined transmission path or a recording medium or the like, and is decoded therein.

FIG. 15 shows the structure of the image decoding device. The image decoding device 50 includes an accumulation buffer 51, a lossless decoding unit 52, an inverse quantization unit 53, an inverse orthogonal transform unit 54, an addition unit 55, a deblocking filter 56, a screen rearrangement buffer 57, and a digital/analog converter (a D/A converter) 58. The image decoding device 50 further includes a frame memory 61, selectors 62 and 75, an intra prediction unit 71, a motion compensation unit 72, and a predicted motion vector information setting unit 73.

The accumulation buffer 51 stores transmitted compressed image information. The lossless decoding unit 52 decodes the compressed image information supplied from the accumulation buffer 51 by a method compatible with the encoding method used by the lossless encoding unit 16 shown in FIG. 7.

The lossless decoding unit 52 outputs the prediction mode information obtained by decoding the compressed image information to the intra prediction unit 71 and the motion compensation unit 72. The lossless decoding unit 52 also outputs predicted block information (a predicted block flag) and difference motion vector information obtained by decoding the compressed image information to the motion compensation unit 72.

The inverse quantization unit 53 inversely quantizes the quantized data decoded by the lossless decoding unit 52, using a method compatible with the quantization method used by the quantization unit 15 shown in FIG. 7. The inverse orthogonal transform unit 54 performs an inverse orthogonal transform on the output from the inverse quantization unit 53 by a method compatible with the orthogonal transform method used by the orthogonal transform unit 14 shown in FIG. 7, and outputs the result to the addition unit 55.

The addition unit 55 generates decoded image data by adding the data subjected to the inverse orthogonal transform to predicted image data supplied from the selector 75, and outputs the decoded image data to the deblocking filter 56 and the frame memory 61.

The deblocking filter 56 performs a deblocking filtering operation on the decoded image data supplied from the addition unit 55, and removes block distortions. The resultant data is supplied to and stored in the frame memory 61, and is also output to the screen rearrangement buffer 57.

The screen rearrangement buffer 57 performs image rearrangement. Specifically, the frame order rearranged in the order of encoding at the screen rearrangement buffer 12 shown in FIG. 7 is rearranged in the original display order, and is output to the D/A converter 58.

The D/A converter 58 performs a D/A conversion on the image data supplied from the screen rearrangement buffer 57, and outputs the converted image data to a display (not shown) to display the image.

The frame memory 61 stores the decoded image data yet to be subjected to the filtering operation at the deblocking filter 24, and the decoded image data subjected to the filtering operation at the deblocking filter 24.

Based on the prediction mode information supplied from the lossless decoding unit 52, the selector 62 supplies the decoded image data that is yet to be subjected to the filtering operation and is stored in the frame memory 61, to the intra prediction unit 71, when intra-predicted image decoding is performed. When inter-predicted image decoding is performed, the selector 62 supplies the decoded image data that has been subjected to the filtering operation and is stored in the frame memory 61, to the motion compensation unit 72.

Based on the prediction mode information supplied from the lossless decoding unit 52 and the decoded image data supplied from the frame memory 61 via the selector 62, the intra prediction unit 71 generates predicted image data, and outputs the generated predicted image data to the selector 75.

The motion compensation unit 72 adds difference motion vector information supplied from the lossless decoding unit 52 to predicted motion vector information supplied from the predicted motion vector information setting unit 73, to generate the motion vector information about the block being decoded. Based on the generated motion vector information and the prediction mode information supplied from the lossless decoding unit 52, the motion compensation unit 72 also performs motion compensation to generate predicted image data by using the decoded image data supplied from the frame memory 61, and outputs the predicted image data to the selector 75.

Based on the predicted block information supplied from the lossless decoding unit 52, the predicted motion vector information setting unit 73 sets predicted motion vector information. The predicted motion vector information setting unit 73 sets predicted horizontal motion vector information about the current block, and the set predicted horizontal motion vector information is the horizontal motion vector information about the block indicated by predicted horizontal block flag information in a decoded adjacent block. Also, the vertical motion vector information about the block indicated by a predicted vertical block flag in the decoded adjacent block is set as predicted vertical motion vector information. The predicted motion vector information setting unit 73 outputs the set predicted horizontal motion vector information and vertical motion vector information to the motion compensation unit 72.

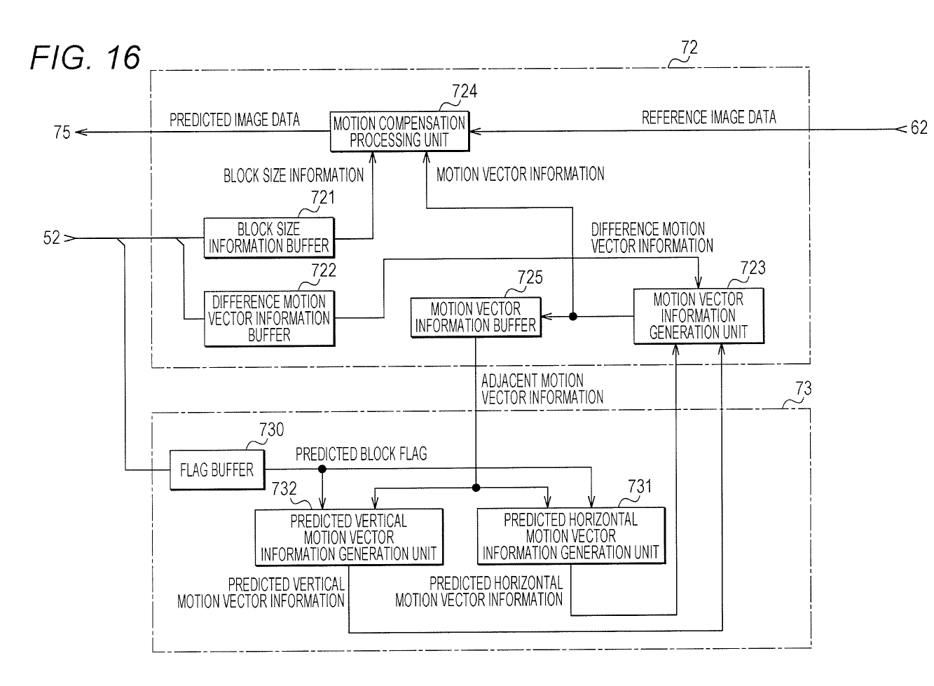

FIG. 16 shows the structures of the motion compensation unit 72 and the predicted motion vector information setting unit 73.

The motion compensation unit 72 includes a block size information buffer 721, a difference motion vector information buffer 722, a motion vector information generation unit 723, a motion compensation processing unit 724, and a motion vector information buffer 725.

The block size information buffer 721 stores block size information contained in the prediction mode information supplied from the lossless decoding unit 52. The block size information buffer 721 also outputs the stored block size information to the motion compensation processing unit 724 and the predicted motion vector information setting unit 73.

The difference motion vector information buffer 722 stores the difference motion vector information supplied from the lossless decoding unit 52. The difference motion vector information buffer 722 also outputs the stored difference motion vector information to the motion vector information generation unit 723.

The motion vector information generation unit 723 adds horizontal difference motion vector information supplied from the difference motion vector information buffer 722 to predicted horizontal motion vector information set by the predicted motion vector information setting unit 73. The motion vector information generation unit 723 also adds vertical difference motion vector information supplied from the difference motion vector information buffer 722 to predicted vertical motion vector information set by the predicted motion vector information setting unit 73. The motion vector information generation unit 723 outputs the motion vector information obtained by adding the difference motion vector information to the predicted motion vector information, to the motion compensation processing unit 724 and the motion vector information buffer 725.

Based on the prediction mode information supplied from the lossless decoding unit 52, the motion compensation processing unit 724 reads the image data of a reference image from the frame memory 61. Based on the image data of the reference image, the block size information supplied from the block size information buffer 721, and the motion vector information supplied from the motion vector information generation unit 723, the motion compensation processing unit 724 performs motion compensation. The motion compensation processing unit 724 outputs the predicted image data generated through the motion compensation, to the selector 75.

The motion vector information buffer 725 stores the motion vector information supplied from the motion vector information generation unit 723. The motion vector information buffer 725 also outputs the stored motion vector information to the predicted motion vector information setting unit 73.

The predicted motion vector information setting unit 73 includes a flag buffer 730, a predicted horizontal motion vector information generation unit 731, and a predicted vertical motion vector information generation unit 732.

The flag buffer 730 stores the predicted block flag supplied from the lossless decoding unit 52. The flag buffer 730 also outputs the stored predicted block flag to the predicted horizontal motion vector information generation unit 731 and the predicted vertical motion vector information generation unit 732.

The predicted horizontal motion vector information generation unit 731 selects the motion vector information indicated by the predicted horizontal block flag from the horizontal motion vector information about adjacent blocks stored in the motion vector information buffer 725 of the motion compensation unit 72, and sets the selected motion vector information as the predicted horizontal motion vector information. The predicted horizontal motion vector information generation unit 731 outputs the set predicted horizontal motion vector information to the motion vector information generation unit 723 of the motion compensation unit 72.

The predicted vertical motion vector information generation unit 732 selects the motion vector information indicated by the predicted vertical block flag from the vertical motion vector information about adjacent blocks stored in the motion vector information buffer 725 of the motion compensation unit 72, and sets the selected motion vector information as the predicted vertical motion vector information. The predicted vertical motion vector information generation unit 732 outputs the set predicted vertical motion vector information to the motion vector information generation unit 723 of the motion compensation unit 72.

Referring back to FIG. 15, based on the prediction mode information supplied from the lossless decoding unit 52, the selector 75 selects the intra prediction unit 71 in the case of an intra prediction, and selects the motion compensation unit 72 in the case of an inter prediction. The selector 75 outputs the predicted image data generated at the selected intra prediction unit 71 or motion compensation unit 72, to the addition unit 55.

### [4. Operations of the Image Decoding Device]

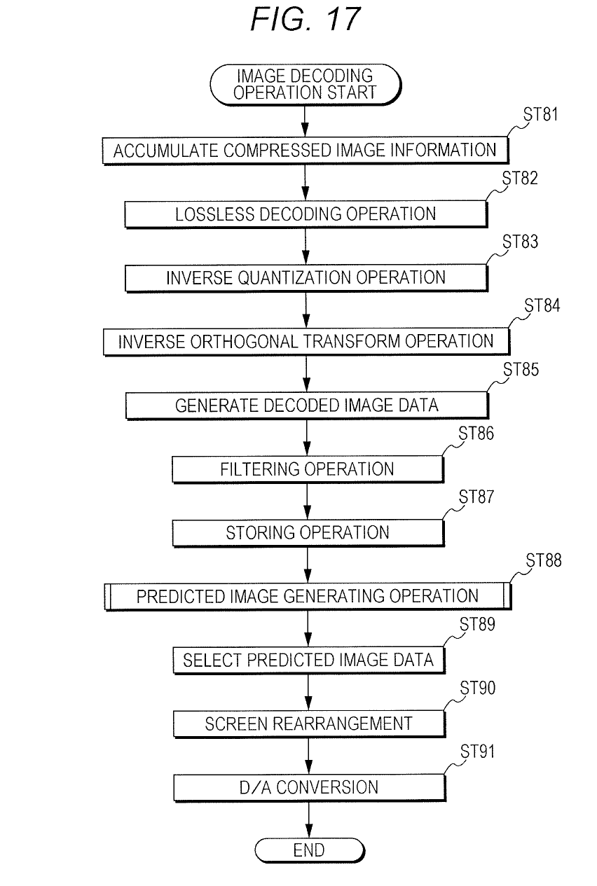

Referring now to the flowchart in FIG. 17, an image decoding operation to be performed by the image decoding device 50 is described.

In step ST81, the accumulation buffer 51 stores transmitted compressed image information. In step ST82, the lossless decoding unit 52 performs a lossless decoding operation. The lossless decoding unit 52 decodes the compressed image information supplied from the accumulation buffer 51. Specifically, the quantized data of each picture encoded at the lossless encoding unit 16 shown in FIG. 7 is obtained. The lossless decoding unit 52 also performs lossless decoding on the prediction mode information contained in the compressed image information. When the obtained prediction mode information is information about an intra prediction mode, the prediction mode information is output to the intra prediction unit 71. When the prediction mode information is information about an inter prediction mode, on the other hand, the lossless decoding unit 52 outputs the prediction mode information to the motion compensation unit 72.

In step ST83, the inverse quantization unit 53 performs an inverse quantization operation. The inverse quantization unit 53 inversely quantizes the quantized data decoded by the lossless decoding unit 52, having characteristics compatible with the characteristics of the quantization unit 15 shown in FIG. 7.

In step ST84, the inverse orthogonal transform unit 54 performs an inverse orthogonal transform operation. The inverse orthogonal transform unit 54 performs an inverse orthogonal transform on the transform coefficient data inversely quantized by the inverse quantization unit 53, having the characteristics compatible with the characteristics of the orthogonal transform unit 14 shown in FIG. 7.

In step ST85, the addition unit 55 generates decoded image data. The addition unit 55 adds the data obtained through the inverse orthogonal transform operation to predicted image data selected in step ST89, which will be described later, and generates the decoded image data. In this manner, the original images are decoded.

In step ST86, the deblocking filter 56 performs a filtering operation. The deblocking filter 56 performs a deblocking filtering operation on the decoded image data output from the addition unit 55, and removes block distortions contained in the decoded images.

In step ST87, the frame memory 61 performs a decoded image data storing operation.

In step ST88, the intra prediction unit 71 and the motion compensation unit 72 perform predicted image generating operations. The intra prediction unit 71 and the motion compensation unit 72 each perform a predicted image generating operation in accordance with the prediction mode information supplied from the lossless decoding unit 52.

Specifically, when prediction mode information about intra predictions has been supplied from the lossless decoding unit 52, the intra prediction unit 71 generates predicted image data based on the prediction mode information. When prediction mode information about inter predictions has been supplied from the lossless decoding unit 52, on the other hand, the motion compensation unit 72 performs motion compensation based on the prediction mode information, to generate predicted image data.

In step ST89, the selector 75 selects predicted image data. The selector 75 selects the predicted image supplied from the intra prediction unit 71 or the predicted image data supplied from the motion compensation unit 72, and supplies the selected predicted image data to the addition unit 55, which adds the selected predicted image data to the output from the inverse orthogonal transform unit 54 in step ST85, as described above.

In step ST90, the screen rearrangement buffer 57 performs image rearrangement. Specifically, the order of frames rearranged for encoding by the screen rearrangement buffer 12 of the image encoding device 10 shown in FIG. 7 is rearranged in the original display order by the screen rearrangement buffer 57.

In step ST91, the D/A converter 58 performs a D/A conversion on the image data supplied from the screen rearrangement buffer 57. The images are output to the display (not shown), and are displayed.

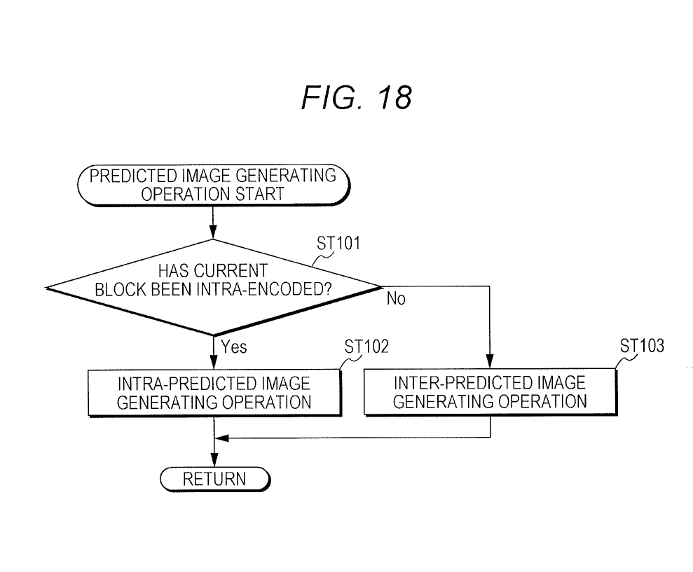

Referring now to the flowchart in FIG. 18, the predicted image generating operation in step ST88 in FIG. 17 is described.

In step ST101, the lossless decoding unit 52 determines whether the current block has been intra-encoded. When the prediction mode information obtained by performing lossless decoding is prediction mode information about intra predictions, the lossless decoding unit 52 supplies the prediction mode information to the intra prediction unit 71, and moves on to step ST102. When the prediction mode information is prediction mode information about inter predictions, on the other hand, the lossless decoding unit 52 supplies the prediction mode information to the motion compensation unit 72, and moves on to step ST103.

In step ST102, the intra prediction unit 71 performs an intra-predicted image generating operation.

Using the prediction mode information and the decoded image data that has not been subjected to the deblocking filtering operation and is stored in the frame memory 61, the intra prediction unit 71 performs an intra prediction, to generate predicted image data.

In step ST103, the motion compensation unit 72 performs an inter-predicted image generating operation. Based on the prediction mode information and difference motion vector information supplied from the lossless decoding unit 52, the motion compensation unit 72 performs motion compensation on a reference image read from the frame memory 61, and generates predicted image data.

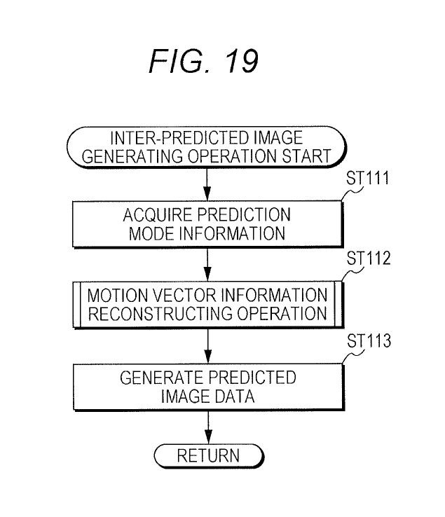

FIG. 19 is a flowchart showing the inter-predicted image generating operation of step ST103. In step ST111, the motion compensation unit 72 obtains prediction mode information. The motion compensation unit 72 obtains the prediction mode information from the lossless decoding unit 52, and moves on to step ST112.

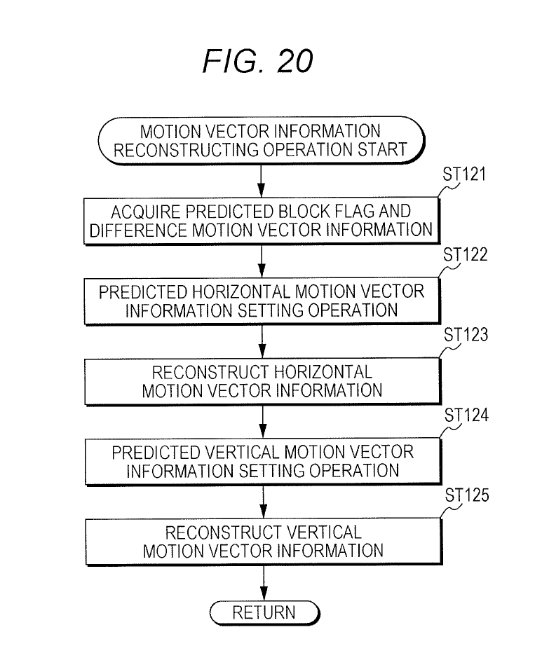

In step ST112, the motion compensation unit 72 and the predicted motion vector information setting unit 73 perform a motion vector information reconstructing operation. FIG. 20 is a flowchart showing the motion vector information reconstructing operation.

In step ST121, the motion compensation unit 72 and the predicted motion vector information setting unit 73 obtain a predicted block flag and difference motion vector information. The motion compensation unit 72 obtains the difference motion vector information from the lossless decoding unit 52. The predicted motion vector information setting unit 73 obtains the predicted block flag from the lossless decoding unit 52, and then moves on to step ST122.

In step ST122, the predicted motion vector information setting unit 73 performs a predicted horizontal motion vector information setting operation. The predicted horizontal motion vector information generation unit 731 selects the horizontal motion vector information about the block indicated by the predicted horizontal block flag from the horizontal motion vector information about adjacent blocks stored in the motion vector information buffer 725 of the motion compensation unit 72. The predicted horizontal motion vector information generation unit 731 sets the selected horizontal motion vector information as the predicted horizontal motion vector information.

In step ST123, the motion compensation unit 72 reconstructs horizontal motion vector information. The motion compensation unit 72 reconstructs the horizontal motion vector information by adding the horizontal difference motion vector information to the predicted horizontal motion vector information, and then moves on to step ST124.

In step ST124, the predicted motion vector information setting unit 73 performs a predicted vertical motion vector information setting operation. The predicted vertical motion vector information generation unit 732 selects the vertical motion vector information about the block indicated by the predicted vertical block flag from the vertical motion vector information about adjacent blocks stored in the motion vector information buffer 725 of the motion compensation unit 72. The predicted vertical motion vector information generation unit 732 sets the selected vertical motion vector information as the predicted vertical motion vector information.

In step ST125, the motion compensation unit 72 reconstructs vertical motion vector information. The motion compensation unit 72 reconstructs the vertical motion vector information by adding the vertical difference motion vector information to the predicted vertical motion vector information, and then moves on to step ST113 in FIG. 19.

In step ST113, the motion compensation unit 72 generates predicted image data. Based on the prediction mode information obtained in step ST111 and the motion vector information reconstructed in step ST112, the motion compensation unit 72 performs motion compensation by reading the reference image data from the frame memory 61, and generates and outputs predicted image data to the selector 75.

As described above, in the image decoding device 50, the horizontal motion vector information about the adjacent block indicated by the predicted horizontal block flag is set as the predicted horizontal motion vector information, and the vertical motion vector information about the adjacent block indicated by the predicted vertical block flag is set as the predicted vertical motion vector information. Accordingly, motion vector information can be correctly reconstructed, even if predicted horizontal motion vector information and predicted vertical motion vector information are set separately from each other so as to increase the encoding efficiency in the image encoding device 10.

### [5. Other Example Structures of the Image Decoding Device and the Image Decoding Device]

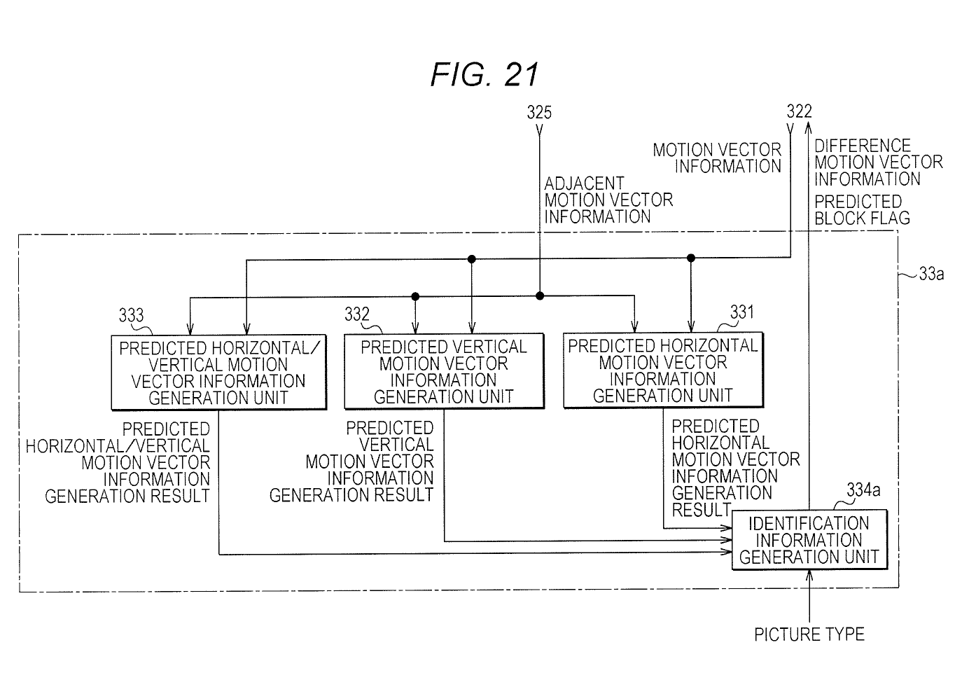

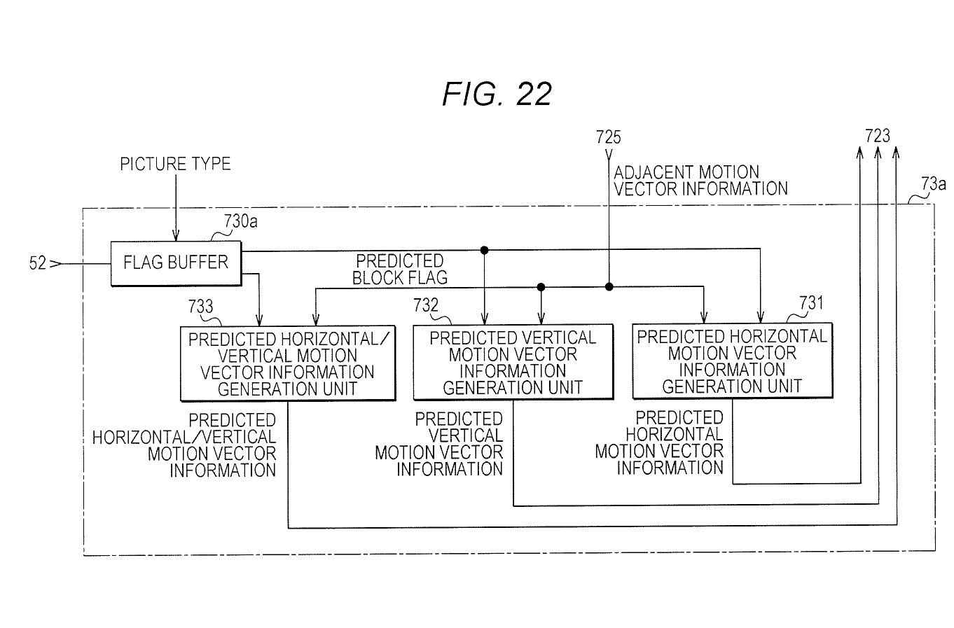

In the above described image encoding device and image decoding device, predicted horizontal motion vector information and predicted vertical motion vector information are set separately from each other, and motion vector information is encoded and decoded. However, optimum encoding efficiency can be achieved if not only predicted horizontal motion vector information and predicted vertical motion vector information can be set separately from each other, but also horizontal/vertical motion vector information can be set. In this case, a predicted motion vector information setting unit 33a used in the image encoding device 10 has the structure shown in FIG. 21. Also, a predicted motion vector information setting unit 73a used in the image decoding device 50 has the structure shown in FIG. 22.

In FIG. 21, a predicted horizontal/vertical motion vector information generation unit 333 sets candidate predicted horizontal motion vector information that is the motion vector information about encoded adjacent blocks supplied from the motion prediction/compensation unit 32. The predicted horizontal/vertical motion vector information generation unit 333 also generates difference motion vector information indicating the difference between the motion vector information about each candidate and the motion vector information about the current block supplied from the motion prediction/compensation unit 32. Further, the predicted horizontal/vertical motion vector information generation unit 333 sets the predicted horizontal/vertical motion vector information that is the motion vector information with the lowest bit rate detected based on the above described equation (23). The predicted horizontal/vertical motion vector information generation unit 333 outputs the predicted horizontal/vertical motion vector information and the difference motion vector information obtained with the use of the predicted horizontal/vertical motion vector information, as the result of the generation of the predicted horizontal/vertical motion vector information to an identification information generation unit 334a.

The identification information generation unit 334a selects the predicted horizontal motion vector information and predicted vertical motion vector information, or the predicted horizontal/vertical motion vector information, and outputs the selected predicted motion vector information, together with the difference motion vector information, to the cost function value calculation unit 322. For example, when the predicted horizontal motion vector information and predicted vertical motion vector information are selected as the predicted motion vector information, the identification information generation unit 334a outputs the predicted horizontal block flag and the horizontal difference motion vector information to the cost function value calculation unit 322, as described above. The identification information generation unit 334a also outputs the predicted vertical block flag and the vertical difference motion vector information to the cost function value calculation unit 322. Further, when the predicted horizontal/vertical motion vector information is selected as the predicted motion vector information, the identification information generation unit 334a generates predicted horizontal/vertical block information indicating the block having its motion vector information selected as the predicted horizontal/vertical motion vector information. For example, the identification information generation unit 334a generates a predicted horizontal/vertical block flag as the predicted horizontal/vertical block information. The identification information generation unit 334a outputs the generated predicted horizontal/vertical block flag and the difference motion vector information to the cost function value calculation unit 322.

The identification information generation unit 334a generates identification information indicating that the predicted horizontal motion vector information and the predicted vertical motion vector information are selected, or that the predicted horizontal/vertical motion vector information is selected. This identification information is supplied to the lossless encoding unit 16 via the motion prediction/compensation unit 32, and is incorporated into the picture parameter set or the slice header of compressed image information.

When selecting predicted motion vector information, the identification information generation unit 334a may switch between the predicted horizontal motion vector information and predicted vertical motion vector information, and the predicted horizontal/vertical motion vector information, for each picture or each slice. Alternatively, when selecting the predicted horizontal motion vector information and predicted vertical motion vector information or the predicted horizontal/vertical motion vector information for each picture, the identification information generation unit 334a may perform the selection in accordance with the picture type of the current block, for example. That is, in a P-picture, even if there is an overhead of the flag information, it is essential to increase the efficiency in motion vector encoding by the amount equivalent to the overhead. Therefore, in the case of a P-picture, the predicted horizontal block flag, the horizontal difference motion vector information, the predicted vertical block flag, and the vertical difference motion vector information are output to the cost function value calculation unit 322. In a B-picture, providing a predicted horizontal block flag and a predicted vertical block flag for List0 prediction and List1 prediction, respectively, does not necessarily realize optimum encoding efficiency, especially at a low bit rate. Therefore, in the case of a B-picture, optimum encoding efficiency can be achieved by outputting the predicted horizontal/vertical block flag and the difference motion vector information to the cost function value calculation unit 322 as in conventional cases.

In FIG. 22, a flag buffer 730a switches destinations of the supply of a predicted block flag, based on the identification information contained in compressed image information. For example, where the predicted horizontal motion vector information and predicted vertical motion vector information are selected, the flag buffer 730a outputs the predicted block flag to the predicted horizontal motion vector information generation unit 731 and the predicted vertical motion vector information generation unit 732. Where the predicted horizontal/vertical motion vector information is selected, the flag buffer 730a outputs the predicted block flag to a predicted horizontal/vertical motion vector information generation unit 733. When predicted motion vector information is switched in accordance with picture types, for example, the flag buffer 730a also switches destinations of the supply of a predicted block flag. In the case of a P-picture, for example, motion vector information has been encoded by using the predicted horizontal motion vector information and predicted vertical motion vector information. In the case of a B-picture, motion vector information has been encoded by using the predicted horizontal/vertical motion vector information. In this case, the flag buffer 730a supplies the predicted block flag to the predicted horizontal motion vector information generation unit 731 and the predicted vertical motion vector information generation unit 732 in the case of a P-picture, and supplies the predicted block flag to the predicted horizontal/vertical motion vector information generation unit 733 in the case of a B-picture.

The lossless encoding unit 16 may also assign different codes to the horizontal direction and the vertical direction. For example, predicted spatial motion vector information and predicted temporal motion vector information can be used as predicted motion vector information. In this case, imaging operations to be performed when moving images to be encoded are generated are taken into consideration, and a code with a small data amount is assigned to predicted motion vector information having high prediction precision. When a captured image is recorded with the later described imaging apparatus, for example, panning is performed with the imaging apparatus, and the imaging direction changes to the horizontal direction. As a result, the motion vector information about the vertical direction becomes almost “0”. At this point, the predicted temporal motion vector information often has high higher prediction precision than the predicted spatial motion vector information in the vertical direction, and the predicted spatial motion vector information often has higher prediction precision than the predicted temporal motion vector information. Therefore, in predicted horizontal block information, code number “0” is assigned to the block of predicted spatial motion vector information, and code number “1” is assigned to the block of predicted temporal motion vector information. Also, as for predicted vertical block information, the code number “1” is assigned to the block of predicted spatial vector information, and the code number “0” is assigned to the block of predicted temporal motion vector information. By assigning different codes between predicted horizontal block information and predicted vertical block information in the above manner, more codes with small data amounts can be used, and accordingly, higher encoding efficiency can be realized.

### [6. Software Processing]

The series of operations described in this specification can be performed by hardware, software, or a combination of hardware and software. When operations are performed by software, a program in which the operation sequences are recorded is installed in a memory incorporated into special-purpose hardware in a computer. Alternatively, the operations can be performed by installing the program into a general-purpose computer that can perform various kinds of operations.

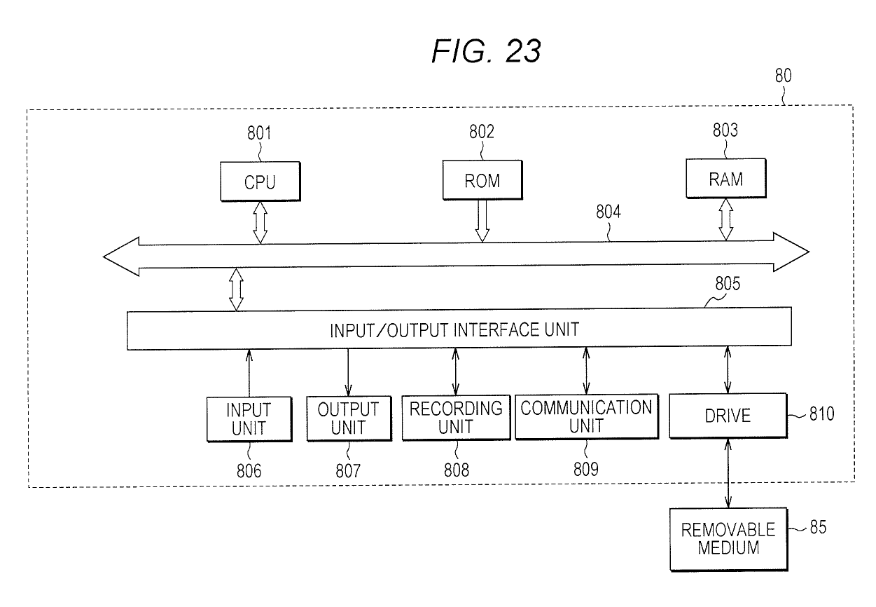

FIG. 23 is a diagram showing an example structure of a computer device that performs the above described series of operations in accordance with a program. A CPU 801 of a computer device 80 performs various kinds of operations in accordance with a program recorded on a ROM 802 or a recording unit 808.

Programs to be executed by the CPU 801 and various kinds of data are stored in a RAM 803 as appropriate. The CPU 801, the ROM 802, and the RAM 803 are connected to one another by a bus 804.

An input/output interface 805 is also connected to the CPU 801 via the bus 804. An input unit 806 such as a touch panel, a keyboard, a mouse, or a microphone, and an output unit 807 formed with a display or the like are connected to the input/output interface 805. The CPU 801 performs various kinds of operations in accordance with instructions that are input through the input unit 806. The CPU 801 outputs the operation results to the output unit 807.

The recording unit 808 connected to the input/output interface 805 is formed with a hard disk, for example, and records programs to be executed by the CPU 801 and various kinds of data. A communication unit 809 communicates with an external device via a wired or wireless communication medium such as a network like the Internet or a local area network, or digital broadcasting. Alternatively, the computer device 80 may obtain a program via the communication unit 809, and record the program on the ROM 802 or the recording unit 808.

When a removable medium 85 that is a magnetic disk, an optical disk, a magnetooptical disk, a semiconductor memory, or the like is mounted, a drive 810 drives the medium, to obtain a recorded program or recorded data. The obtained program or data is transferred to the ROM 802, the RAM 803, or the recording unit 808, where necessary.

The CPU 801 reads and executes the program for performing the above described series of operations, to perform encoding operations on image signals recorded on the recording unit 808 or the removable medium 85 and on image signals supplied via the communication unit 809, and perform decoding operations on compressed image information.

### [7. Applications to Electronic Apparatuses]

In the above described examples, H.264/AVC is used as the encoding/decoding method. However, the present technique can be applied to image encoding devices and image decoding devices that use other encoding/decoding methods for performing motion prediction/compensation operations.

Further, the present technique can be used when image information (bit streams) compressed through orthogonal transforms such as discrete cosine transforms and motion compensation, for example, is received via a network medium such as satellite broadcasting, cable TV (television), the Internet, or a portable telephone device. The present technique can also be applied to image encoding devices and image decoding devices that are used when compressed image information is processed on a storage medium such as an optical or magnetic disk or a flash memory.

The above described image encoding device 10 and the image decoding device 50 can be applied to any electronic apparatuses. The following is a description of such examples.

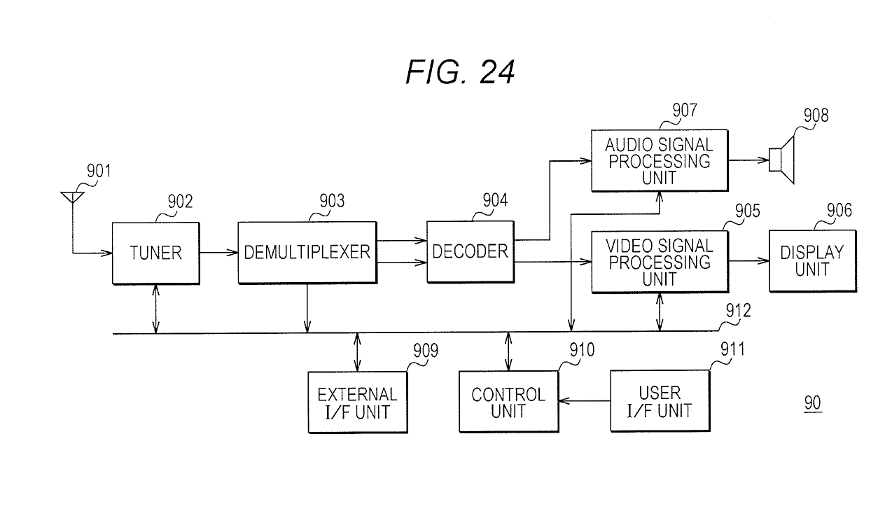

FIG. 24 schematically shows an example structure of a television apparatus to which the present technique is applied. The television apparatus 90 includes an antenna 901, a tuner 902, a demultiplexer 903, a decoder 904, a video signal processing unit 905, a display unit 906, an audio signal processing unit 907, a speaker 908, and an external interface unit 909. The television apparatus 90 further includes a control unit 910, a user interface unit 911, and the like.

The tuner 902 selects a desired channel from broadcast wave signals received at the antenna 901, and performs demodulation. The resultant stream is output to the demultiplexer 903.

The demultiplexer 903 extracts the video and audio packets of the show to be viewed from the stream, and outputs the data of the extracted packets to the decoder 904. The demultiplexer 903 also outputs a packet of data such as EPG (Electronic Program Guide) to the control unit 910. Where scrambling is performed, the demultiplexer or the like cancels the scrambling.

The decoder 904 performs a packet decoding operation, and outputs the video data generated through the decoding operation to the video signal processing unit 905, and the audio data to the audio signal processing unit 907.

The video signal processing unit 905 subjects the video data to denoising and video processing or the like in accordance with user settings. The video signal processing unit 905 generates video data of the show to be displayed on the display unit 906, or generates image data or the like through an operation based on an application supplied via a network. The video signal processing unit 905 also generates video data for displaying a menu screen or the like for item selection, and superimposes the generated video data on the video data of the show. Based on the video data generated in this manner, the video signal processing unit 905 generates a drive signal to drive the display unit 906.

Based on the drive signal from the video signal processing unit 905, the display unit 906 drives a display device (a liquid crystal display element, for example) to display the video of the show.

The audio signal processing unit 907 subjects the audio data to predetermined processing such as denoising, and performs a D/A conversion operation and an amplifying operation on the processed audio data. The resultant audio data is supplied as an audio output to the speaker 908.

The external interface unit 909 is an interface for a connection with an external device or a network, and transmits and receives data such as video data and audio data.

The user interface unit 911 is connected to the control unit 910. The user interface unit 911 is formed with operation switches, a remote control signal reception unit, and the like, and supplies an operating signal according to a user operation to the control unit 910.

The control unit 910 is formed with a CPU (Central Processing Unit), a memory, and the like. The memory stores the program to be executed by the CPU, various kinds of data necessary for the CPU to perform operations, EPG data, data obtained via a network, and the like. The program stored in the memory is read and executed at the CPU at a predetermined time such as the time of activation of the television apparatus 90. The CPU executes the program to control the respective components so that the television apparatus 90 operates in accordance with user operations.

In the television apparatus 90, a bus 912 is provided for connecting the tuner 902, the demultiplexer 903, the video signal processing unit 905, the audio signal processing unit 907, the external interface unit 909, and the like to the control unit 910.

In the television apparatus having such a structure, the decoder 904 has the functions of an image decoding device (an image decoding method) of the present invention. Accordingly, based on generated predicted motion vector information and received difference motion vector information, the television apparatus can correctly decompress the motion vector information about a current block to be decoded. Thus, the television apparatus can perform correct decoding, even when a broadcast station sets predicted horizontal motion vector information and predicted vertical motion vector information separately from each other so as to increase encoding efficiency.

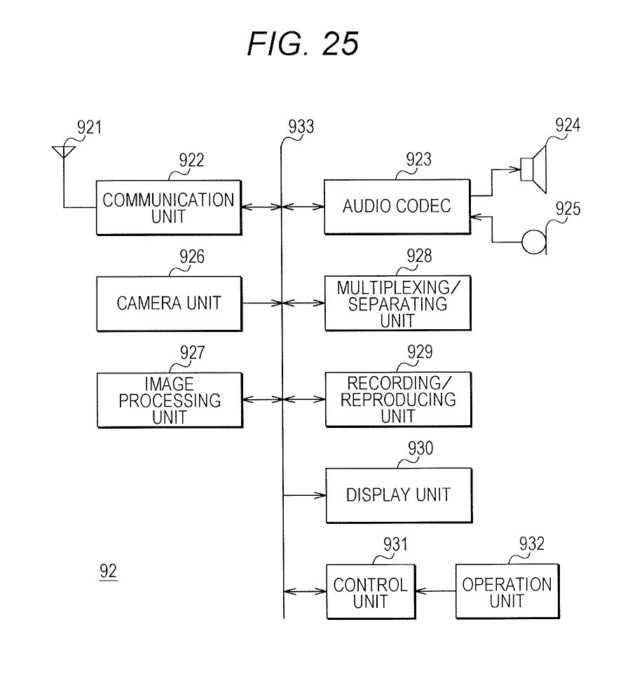

FIG. 25 schematically shows an example structure of a portable telephone device to which the present technique is applied. The portable telephone device 92 includes a communication unit 922, an audio codec 923, a camera unit 926, an image processing unit 927, a multiplexing/separating unit 928, a recording/reproducing unit 929, a display unit 930, and a control unit 931. Those components are connected to one another via a bus 933.

Also, an antenna 921 is connected to the communication unit 922, and a speaker 924 and a microphone 925 are connected to the audio codec 923. Further, an operation unit 932 is connected to the control unit 931.

The portable telephone device 92 performs various kinds of operations such as transmission and reception of audio signals, transmission and reception of electronic mail and image data, image capturing, and data recording, in various kinds of modes such as an audio communication mode and a data communication mode.

In the audio communication mode, an audio signal generated at the microphone 925 is converted into audio data, and the data is compressed at the audio codec 923. The compressed data is supplied to the communication unit 922. The communication unit 922 performs a modulation operation, a frequency conversion operation, and the like on the audio data, to generate a transmission signal. The communication unit 922 also supplies the transmission signal to the antenna 921, and the transmission signal is transmitted to a base station (not shown). The communication unit 922 also amplifies a signal received at the antenna 921, and performs a frequency conversion operation, a demodulation operation, and the like. The resultant audio data is supplied to the audio codec 923. The audio codec 923 decompresses audio data, and converts the audio data into an analog audio signal. The analog audio signal is then output to the speaker 924.

In a case where mail transmission is performed in the data communication mode, the control unit 931 receives text data that is input through an operation by the operation unit 932, and the input text is displayed on the display unit 930. In accordance with a user instruction or the like through the operation unit 932, the control unit 931 generates and supplies mail data to the communication unit 922. The communication unit 922 performs a modulation operation, a frequency conversion operation, and the like on the mail data, and transmits the resultant transmission signal from the antenna 921. The communication unit 922 also amplifies a signal received at the antenna 921, and performs a frequency conversion operation, a demodulation operation, and the like, to decompress the mail data. This mail data is supplied to the display unit 930, and the mail content is displayed.

The portable telephone device 92 can cause the recording/reproducing unit 929 to store received mail data into a storage medium. The storage medium is a rewritable storage medium. For example, the storage medium may be a semiconductor memory such as a RAM or an internal flash memory, a hard disk, or a removable medium such as a magnetic disk, a magnetooptical disk, an optical disk, a USB memory, or a memory card.

In a case where image data is transmitted in the data communication mode, image data generated at the camera unit 926 is supplied to the image processing unit 927. The image processing unit 927 performs an encoding operation on the image data, to generate compressed image information.

The multiplexing/separating unit 928 multiplexes the compressed image information generated at the image processing unit 927 and the audio data supplied from the audio codec 923 by a predetermined method, and supplies the multiplexed data to the communication unit 922. The communication unit 922 performs a modulation operation, a frequency conversion operation, and the like on the multiplexed data, and transmits the resultant transmission signal from the antenna 921. The communication unit 922 also amplifies a signal received at the antenna 921, and performs a frequency conversion operation, a demodulation operation, and the like, to decompress the multiplexed data. This multiplexed data is supplied to the multiplexing/separating unit 928. The multiplexing/separating unit 928 divides the multiplexed data, and supplies the compressed image information to the image processing unit 927, and the audio data to the audio codec 923.

The image processing unit 927 performs a decoding operation on the compressed image information, to generate image data. This image data is supplied to the display unit 930, to display the received images. The audio codec 923 converts the audio data into an analog audio signal, and supplies the analog audio signal to the speaker 924, so that the received sound is output.

In the portable telephone device having the above structure, the image processing unit 927 has the functions of an image encoding device (an image encoding method) and an image decoding device (an image decoding method) of the present invention. Accordingly, when an image is transmitted, predicted horizontal motion vector information about the horizontal component of the motion vector information about a current block, and predicted vertical motion vector information about the vertical component are set separately from each other, so that encoding efficiency can be increased. Also, compressed image information generated through image encoding operations can be correctly decoded.

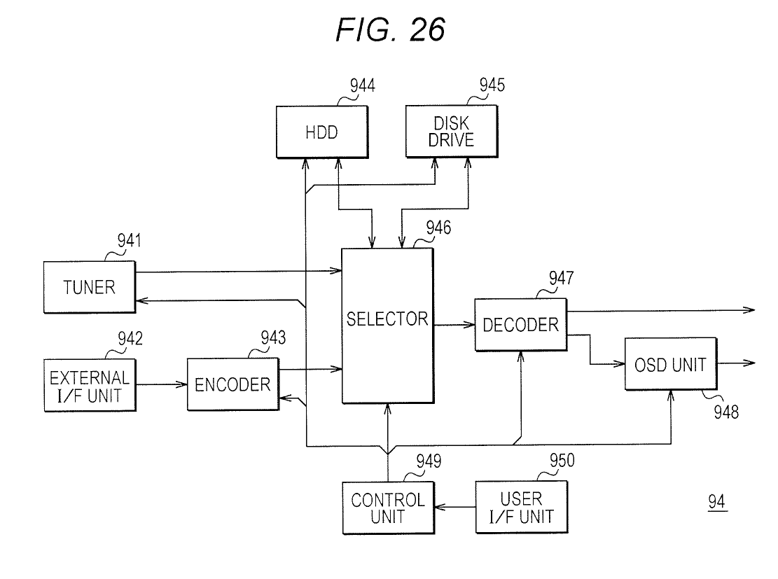

FIG. 26 schematically shows an example structure of a recording/reproducing apparatus to which the present technique is applied. The recording/reproducing apparatus 94 records the audio data and video data of a received broadcast show on a recording medium, and provides the recorded data to a user at a time according to an instruction from the user. The recording/reproducing apparatus 94 can also obtain audio data and video data from another apparatus, for example, and record the data on a recording medium. Further, the recording/reproducing apparatus 94 decodes and outputs audio data and video data recorded on a recording medium, so that a monitor device or the like can display images and outputs sound.

The recording/reproducing apparatus 94 includes a tuner 941, an external interface unit 942, an encoder 943, a HDD (Hard Disk Drive) unit 944, a disk drive 945, a selector 946, a decoder 947, an OSD (On-Screen Display) unit 948, a control unit 949, and a user interface unit 950.

The tuner 941 selects a desired channel from broadcast signals received at an antenna (not shown). The tuner 941 demodulates the received signal of the desired channel, and outputs the resultant compressed image information to the selector 946.

The external interface unit 942 is formed with at least one of an IEEE1394 interface, a network interface unit, a USB interface, a flash memory interface, and the like. The external interface unit 942 is an interface for a connection with an external device, a network, a memory card, or the like, and receives data such as video data and audio data to be recorded, and the like.

The encoder 943 performs predetermined encoding on video data and audio data that have been supplied from the external interface unit 942 and have not been encoded, and outputs the compressed image information to the selector 946.

The HDD unit 944 records content data such as videos and sound, various kinds of programs, other data, and the like on an internal hard disk, and reads the data from the hard disk at the time of reproduction or the like.

The disk drive 945 performs signal recording and reproduction on a mounted optical disk. The optical disk may be a DVD disk (such as a DVD-Video, a DVD-RAM, a DVD-R, a DVD-RW, a DVD+R, or a DVD+RW) or a Blu-ray disk, for example.

The selector 946 selects a stream from the tuner 941 or the encoder 943 at the time of video and audio recording, and supplies the stream to either the HDD unit 944 or the disk drive 945. The selector 946 also supplies a stream output from the HDD unit 944 or the disk drive 945 to the decoder 947 at the time of video and audio reproduction.

The decoder 947 performs a decoding operation on the stream. The decoder 947 supplies the video data generated by performing the decoding to the OSD unit 948. The decoder 947 also outputs the audio data generated by performing the decoding.

The OSD unit 948 generates video data for displaying a menu screen or the like for item selection, and superimposes the video data on video data output from the decoder 947.

The user interface unit 950 is connected to the control unit 949. The user interface unit 950 is formed with operation switches, a remote control signal reception unit, and the like, and supplies an operating signal according to a user operation to the control unit 949.

The control unit 949 is formed with a CPU, a memory, and the like. The memory stores the program to be executed at the CPU and various kinds of data necessary for the CPU to perform operations. The program stored in the memory is read and executed by the CPU at a predetermined time such as the time of activation of the recording/reproducing apparatus 94. The CPU executes the program to control the respective components so that the recording/reproducing apparatus 94 operates in accordance with user operations.

In the recording/reproducing apparatus having the above structure, the encoder 943 has the functions of an image encoding device (an image encoding method) of the present invention. The decoder 947 also has the functions of an image decoding device (an image decoding method) of the present invention. Accordingly, when an image is recorded on a recording medium, predicted horizontal motion vector information about the horizontal component of the motion vector information about a current block, and predicted vertical motion vector information about the vertical component are set separately from each other, so that encoding efficiency can be increased. Also, compressed image information generated through image encoding operations can be correctly decoded.

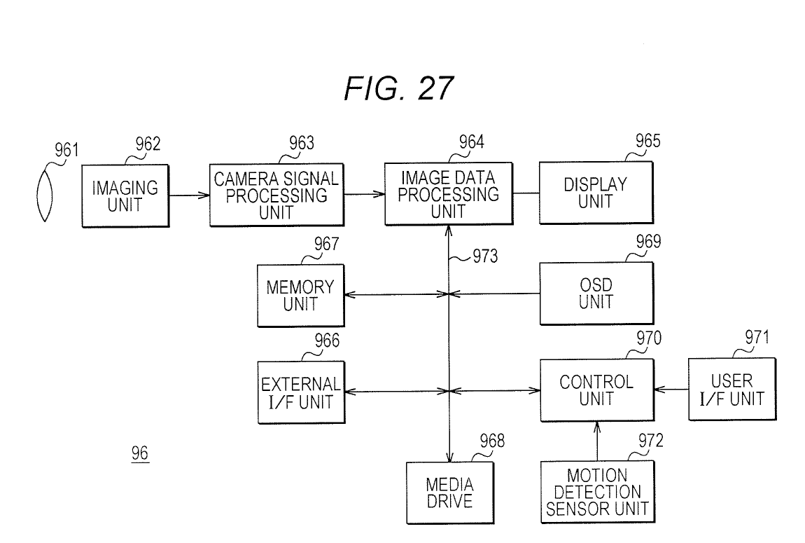

FIG. 27 schematically shows an example structure of an imaging apparatus to which the present technique is applied. An imaging apparatus 96 captures an image of an object, and causes a display unit to display the image of the object or records the image as image data on a recording medium.

The imaging apparatus 96 includes an optical block 961, an imaging unit 962, a camera signal processing unit 963, an image data processing unit 964, a display unit 965, an external interface unit 966, a memory unit 967, a media drive 968, an OSD unit 969, and a control unit 970. A user interface unit 971 and a motion detection sensor unit 972 are connected to the control unit 970. Further, the image data processing unit 964, the external interface unit 966, the memory unit 967, the media drive 968, the OSD unit 969, the control unit 970, and the like are connected via a bus 973.

The optical block 961 is formed with a focus lens, a diaphragm, and the like. The optical block 961 forms an optical image of an object on the imaging surface of the imaging unit 962. Formed with a CCD or a CMOS image sensor, the imaging unit 962 generates an electrical signal in accordance with the optical image through a photoelectric conversion, and supplies the electrical signal to the camera signal processing unit 963.

The camera signal processing unit 963 performs various kinds of camera signal processing such as a knee correction, a gamma correction, and a color correction on the electrical signal supplied from the imaging unit 962. The camera signal processing unit 963 supplies the image data subjected to the camera signal processing, to the image data processing unit 964.

The image data processing unit 964 performs an encoding operation on the image data supplied from the camera signal processing unit 963. The image data processing unit 964 supplies the compressed image information generated by performing the encoding operation, to the external interface unit 966 and the media drive 968. The image data processing unit 964 also performs a decoding operation on compressed image information supplied from the external interface unit 966 and the media drive 968. The image data processing unit 964 supplies the image data generated by performing the decoding operation, to the display unit 965. The image data processing unit 964 also performs an operation to supply the image data supplied from the camera signal processing unit 963 to the display unit 965, or superimposes display data obtained from the OSD unit 969 on the image data and supplies the image data to the display unit 965.

The OSD unit 969 generates a menu screen formed with symbols, characters, or figures, or display data such as icons, and outputs such data to the image data processing unit 964.

The external interface unit 966 is formed with a USB input/output terminal and the like, for example, and is connected to a printer when image printing is performed. A drive is also connected to the external interface unit 966 where necessary, and a removable medium such as a magnetic disk or an optical disk is mounted on the drive as appropriate. A program read from such a removable disk is installed where necessary. Further, the external interface unit 966 includes a network interface connected to a predetermined network such as a LAN or the Internet. The control unit 970 reads compressed image information from the memory unit 967 in accordance with an instruction from the user interface unit 971, for example, and can supply the compressed image information from the external interface unit 966 to another apparatus connected thereto via a network. The control unit 970 can also obtain, via the external interface unit 966, compressed image information or image data supplied from another apparatus via a network, and supply the compressed image information or image data to the image data processing unit 964.

A recording medium to be driven by the media drive 968 may be a readable/rewritable removable disk such as a magnetic disk, a magnetooptical disk, an optical disk, or a semiconductor memory. The recording medium may be any type of removable medium, and may be a tape device, a disk, or a memory card. The recording medium may of course be a non-contact IC card or the like.

Alternatively, the media drive 968 and a recording medium may be integrated, and may be formed with an immobile storage medium such as an internal hard disk drive or a SSD (Solid State Drive).

The control unit 970 is formed with a CPU, a memory, and the like. The memory stores the program to be executed at the CPU, various kinds of data necessary for the CPU to perform operations, and the like. The program stored in the memory is read and executed by the CPU at a predetermined time such as the time of activation of the imaging apparatus 96. The CPU executes the program to control the respective components so that the imaging apparatus 96 operates in accordance with a user operation.

In the imaging apparatus having the above structure, the image data processing unit 964 has the functions of an image encoding device (an image encoding method) and an image decoding device (an image decoding method) of the present invention. Accordingly, when a captured image is recorded, predicted horizontal motion vector information about the horizontal component of the motion vector information about a current block, and predicted vertical motion vector information about the vertical component are set separately from each other, so that encoding efficiency can be increased. Also, compressed image information generated through image encoding operations can be correctly decoded.

Further, the motion detection sensor unit 972 formed with a gyro or the like is provided in the imaging apparatus 96, and codes with small data amounts are assigned to predicted motion vector information having high prediction precision, based on the results of detection of motions such as panning or tilting of the imaging apparatus 96. By dynamically assigning codes in accordance with the results of motion detection performed on the imaging apparatus in the above manner, encoding efficiency can be further increased.

It should be noted that the present technique should not be interpreted to be limited to the above described embodiments. The embodiments disclose the present technique through examples, and it should be obvious that those skilled in the art can modify or replace those embodiments with other embodiments without departing from the scope of the technique. That is, the claims should be taken into account in understanding the subject matter of the technique.

### INDUSTRIAL APPLICABILITY

With an image encoding device and a motion vector encoding method, and an image decoding device and a motion vector decoding method of this technique, predicted horizontal motion vector information and predicted vertical motion vector information are set for the horizontal component and the horizontal component of motion vector information about a current block by selecting motion vector information from encoded blocks adjacent to the current block, and the motion vector information about the current block is compressed by using the set predicted horizontal motion vector information and predicted vertical motion vector information. Also, predicted horizontal block information and predicted vertical block information indicating the block having its motion vector information selected are generated. Further, the motion vector information is decoded based on the predicted horizontal block information and the predicted vertical block information. Accordingly, predicted horizontal motion vector information and predicted vertical motion vector information can be set by using predicted horizontal block information and predicted vertical block information having smaller data amounts than a flag equivalent to a combination of candidates for the predicted horizontal motion vector information and the predicted vertical motion vector information. Thus, encoding efficiency can be increased. Accordingly, high encoding efficiency can be realized. In view of this, the technique is suitable for transmitting and receiving compressed image information (bit streams) via a network medium such as satellite broadcasting, cable TV, the Internet, or portable telephones, or for devices and the like that perform image recording and reproduction by using storage media such as optical disks, magnetic disks, and flash memories.

### REFERENCE SIGNS LIST

10 . . . Image encoding device 11 . . . A/D converter 12, 57 . . . Screen rearrangement buffer 13 . . . Subtraction unit 14 . . . Orthogonal transform unit 15 . . . Quantization unit 16 . . . Lossless encoding unit 17, 51 . . . Accumulation buffer 18 . . . Rate control unit 21, 53 . . . Inverse quantization unit 22, 54 . . . Inverse orthogonal transform unit 23, 55 . . . Addition unit 24, 56 . . . Deblocking filter 25, 61 . . . Frame memory 26, 62, 75 . . . Selector 31, 71 . . . Intra prediction unit 32 . . . Motion prediction/compensation unit 33, 33a, 73, 73a . . . Predicted motion vector information setting unit 35 . . . Predicted image/optimum mode selection unit 50 . . . Image decoding device 52 . . . Lossless decoding unit 58 . . . D/A converter 72 . . . Motion compensation unit 80 . . . Computer device 90 . . . Television apparatus 92 . . . Portable telephone device 94 . . . Recording/reproducing apparatus 96 . . . Imaging apparatus 321 . . . Motion search unit 322 . . . Cost function value calculation unit 323 . . . Mode determination unit 324 . . . Motion compensation processing unit 325 . . . Motion vector buffer 331, 731 . . . Predicted horizontal motion vector information generation unit 332, 732 . . . Predicted vertical motion vector information generation unit 333, 733 . . . Predicted horizontal/vertical motion vector information generation unit 334, 334a . . . Identification information generation unit 721 . . . Block size information buffer 722 . . . Difference motion vector information buffer 723 . . . Motion vector information generation unit 724 . . . Motion compensation processing unit 725 . . . Motion vector information buffer 730, 730a . . . Flag buffer

1. An image decoding device comprising:
a lossless decoding unit configured to obtain predicted horizontal block information and predicted vertical block information from compressed image information, the predicted horizontal block information indicating a block having motion vector information selected as predicted horizontal motion vector information from decoded blocks adjacent to a current block, the predicted vertical block information indicating a block having motion vector information selected as predicted vertical motion vector information from the decoded adjacent blocks;
a predicted motion vector information setting unit configured to set the predicted horizontal motion vector information that is motion vector information about the block indicated by the predicted horizontal block information, and set the predicted vertical motion vector information that is motion vector information about the block indicated by the predicted vertical block information; and
a motion vector information generation unit configured to generate motion vector information about the current block by using the predicted horizontal motion vector information and predicted vertical motion vector information set by the predicted motion vector information setting unit.

2. The image decoding device according to claim 1, wherein
the lossless decoding unit obtains identification information from the compressed image information, the identification information indicating that the predicted horizontal motion vector information and the predicted vertical motion vector information are used or that predicted horizontal/vertical motion vector information is used, the predicted horizontal/vertical motion vector information indicating motion vector information selected from the decoded adjacent blocks for a horizontal component and a vertical component of the motion vector information about the current block,
based on the identification information, the predicted motion vector information setting unit sets the predicted horizontal motion vector information and the predicted vertical motion vector information, or sets the predicted horizontal/vertical motion vector information, and
the motion vector information generation unit generates the motion vector information about the current block by using the predicted horizontal motion vector information and the predicted vertical motion vector information, or using the predicted horizontal/vertical motion vector information.

3. The image decoding device according to claim 1, wherein
the lossless decoding unit decodes codes contained in the compressed image information, to obtain the predicted horizontal block information and the predicted vertical block information, and
based on the predicted horizontal block information and the predicted vertical block information, the predicted motion vector information setting unit sets the predicted horizontal motion vector and the predicted vertical motion vector information.

4. A motion vector information decoding method comprising the steps of:
obtaining predicted horizontal block information and predicted vertical block information from compressed image information, the predicted horizontal block information indicating a block having motion vector information selected as predicted horizontal motion vector information from decoded blocks adjacent to a current block, the predicted vertical block information indicating a block having motion vector information selected as predicted vertical motion vector information from the decoded adjacent blocks;
setting the predicted horizontal motion vector information that is motion vector information about the block indicated by the predicted horizontal block information, and sets the predicted vertical motion vector information that is motion vector information about the block indicated by the predicted vertical block information; and
generating motion vector information about the current block by using the set predicted horizontal motion vector information and predicted vertical motion vector information.

5. An image encoding device comprising:
a predicted motion vector information setting unit configured to set, for a horizontal component and a vertical component of motion vector information about a current block, respectively, predicted horizontal motion vector information and predicted vertical motion vector information by selecting motion vector information from encoded blocks adjacent to the current block, and generate predicted horizontal block information and predicted vertical block information indicating the block having the motion vector information selected.

6. The image encoding device according to claim 5, wherein the predicted motion vector information setting unit selects motion vector information with the highest encoding efficiency in an encoding operation for the horizontal component and sets the selected motion vector information as the predicted horizontal motion vector information, and selects motion vector information with the highest encoding efficiency in an encoding operation for the vertical component and sets the selected motion vector information as the predicted vertical motion vector information.

7. The image encoding device according to claim 6, further comprising:
a cost function value calculation unit configured to calculate a cost function value in each prediction mode; and
a mode determination unit configured to determine an optimum prediction mode,
wherein the mode determination unit determines a mode having the smallest one of the calculated cost function values to be the optimum prediction mode.

8. The image encoding device according to claim 5, wherein the predicted horizontal block information and the predicted vertical block information are incorporated into compressed image information and are transmitted.

9. The image encoding device according to claim 5, wherein the predicted motion vector information setting unit is capable of switching, for each picture or each slice, between setting the motion vector information selected from the encoded blocks adjacent to the current block as predicted horizontal/vertical motion vector information and setting the motion vector information as the predicted horizontal motion vector information and predicted vertical motion vector information, for the horizontal component and the vertical component of the motion vector information about the current block.

10. The image encoding device according to claim 9, wherein the predicted motion vector information setting unit generates identification information indicating that the predicted horizontal motion vector information and the predicted vertical motion vector information are used, or that the predicted horizontal/vertical motion vector information is used.

11. The image encoding device according to claim 10, wherein the generated identification information is incorporated into a picture parameter set or a slice header of compressed image information.

12. The image encoding device according to claim 9, wherein the predicted motion vector information setting unit sets the predicted horizontal motion vector information and predicted vertical motion vector information for a P-picture, and sets the predicted horizontal/vertical motion vector information for a B-picture.

13. The image encoding device according to claim 5, further comprising
a lossless encoding unit configured to encode the motion vector information about the current block,
wherein the lossless encoding unit assigns different codes to the predicted horizontal block information and the predicted vertical block information, and incorporates the codes assigned to the predicted horizontal block information and the predicted vertical block information into compressed image information.

14. The image encoding device according to claim 13, wherein the lossless encoding unit assigns different codes to predicted block information indicating a block having motion vector information selected as predicted spatial motion vector information, and to predicted block information indicating a block having motion vector information selected as predicted temporal motion vector information, the codes being different between the predicted horizontal block information and the predicted vertical block information.

15. The image encoding device according to claim 14, wherein, when an encoding operation is performed on the motion vector information about the current block detected by using image data generated by an imaging apparatus, the lossless encoding unit assigns the codes based on a result of motion detection performed on the imaging apparatus.

16. A motion vector information encoding method comprising the step of
setting, for a horizontal component and a vertical component of motion vector information about a current block, respectively, predicted horizontal motion vector information and predicted vertical motion vector information by selecting motion vector information from encoded blocks adjacent to the current block, and generating predicted horizontal block information and predicted vertical block information indicating the block having the motion vector information selected.
